(19) United States
(12) Patent Application Publication
(10) Pub. No.: US 2025/0121760 A1
(43) Pub. Date: Apr. 17, 2025

(54) All Encompassing Columnar Lift Assembly

(71) Applicant: MAXON INDUSTRIES, INC., Santa Fe Springs, CA (US)

(72) Inventors: Karapet Ablabutyan, Glendale, CA (US); Levon Hambardzumyan, Glendale, CA (US); Paul Bark, Carlsbad, CA (US); William E. Kreutinger, San Juan Capistrano, CA (US)

(21) Appl. No.: 18/991,036

(22) Filed: Dec. 20, 2024

Related U.S. Application Data
(63) Continuation-in-part of application No. PCT/US24/54922, filed on Nov. 7, 2024.
(63) Continuation-in-part of application No. PCT/US24/35870, filed on Jun. 27, 2024.
(60) Provisional application No. 63/548,951, filed on Feb. 2, 2024.
(60) Provisional application No. 63/547,804, filed on Nov. 8, 2023.
(60) Provisional application No. 63/524,030, filed on Jun. 29, 2023.

(51) Int. Cl. B60P 1/44

(52) U.S. Cl. CPC B60P 1/4421

(57) ABSTRACT

Systems, devices, and methods including at least one column, each including: an assembled parallel pair of a first extrusion and a second extrusion, at least one bracket connecting the first extrusion and the second extrusion as one piece, and at least one runner configured to slide along an internal space defined by the first extrusion and the second extrusion; and a lift platform connected to the at least one runner.

### CROSS-REFERENCE TO RELATED APPLICATION

This application claims priority to and the benefit of U.S. Provisional Patent Application No. 63/548,951, filed Feb. 2, 2024; this application is a continuation-in-part of Patent Cooperation Treaty Application No. PCT/US24/35870, filed Jun. 27, 2024, which claims priority to U.S. Provisional Patent Application No. 63/524,030, filed Jun. 29, 2023; and this application is a continuation-in-part of Patent Cooperation Treaty Application No. PCT/US24/54922, filed Nov. 7, 2024, which claims priority to U.S. Provisional Patent Application No. 63/547,804, filed Nov. 8, 2023 the contents of all of which are hereby incorporated by reference herein for all purposes.

### FIELD OF ENDEAVOR

Embodiments relate generally to liftgates, and more particularly to liftgates for column lifts.

### BACKGROUND

One type of a liftgate system comprises a load elevator in the form of a liftgate including a dual lift system having a parallel pair of vertically extending columns, each having a vertically-disposed hydraulic cylinder for vertically raising and lowering a load carried by the pair of cylinders.

Such a liftgate includes a rigid H-frame having said parallel pair of upstanding columns. The columns contain a corresponding pair of vertically-disposed hydraulic cylinders having runners interconnected by a transverse stabilizing bar typically supporting a two-section foldable lifting platform actuated on each side by an actuating linkage system.

Liftgates are typically mounted at a structure such as an opening at the rear of a vehicle to lift payloads on a lift platform from one level (e.g., ground level) up to another level (e.g., the bed of the vehicle), and vice versa.

### SUMMARY

A system embodiment may include: at least one column, each including: an assembled parallel pair of a first extrusion and a second extrusion, at least one assembly bracket connecting the first extrusion and the second extrusion as one piece, and at least one runner configured to slide along an internal space defined by the first extrusion and the second extrusion; and a lift platform connected to the at least one runner.

A system embodiment may include: at least one column, each including: an assembled parallel pair of a first extrusion and a second extrusion, at least one bracket connecting the first extrusion and the second extrusion as one piece, and at least one runner configured to slide along an internal space defined by the first extrusion and the second extrusion; and a lift platform connected to the at least one runner.

In additional system embodiments, each of the first extrusion and the second extrusion includes an L-shape, and where the assembled parallel pair of the first extrusion and the second extrusion includes a C-shape defining the internal space. In additional system embodiments, the at least one bracket includes a top assembly bracket, and where the top assembly bracket includes a four-sided polygon shape that fits the internal space and may be configured to hold and connect the assembled parallel pair.

Additional system embodiments may include: a mounting bracket connected to the back of the assembled parallel pair, and where the mounting bracket may be configured to mount the system to a vehicle. In additional system embodiments, the at least one bracket includes a bottom assembly bracket that may be configured to wrap around the outside of the assembled parallel pair and the mounting bracket and hold and connect the assembled parallel pair.

In additional system embodiments, the first extrusion includes a first extending portion and a second extending portion perpendicular to the first extending portion, where the second extrusion includes a first extending portion and a second extending portion perpendicular to the first extending portion, where the first extending portion of the first extrusion and the first extending portion of the second extrusion may be arranged to extend in the same plane, and ends of the first extending portion of the first extrusion and the first extending portion of the second extrusion may be engaged with each other via a pair of a groove and a tongue, and where surfaces of the second extending portion of the first extrusion and the second extending portion of the second extrusion may be arranged to face each other and extended in a parallel direction.

In additional system embodiments, the internal space defined by the first extrusion and the second extrusion may be configured to contain one or more liftgate movement components. In additional system embodiments, the one or more liftgate movement components contained in the internal space includes one or more hydraulic actuators, and where the hydraulic actuators may be configured to operate the at least one runner to lower and/or raise the lift platform connected to the at least one runner. In additional system embodiments, the one or more liftgate movement components contained in the internal space includes one or more hydraulic hoses that may be configured to provide hydraulic fluid to the one or more hydraulic actuators. In additional system embodiments, the at least one column includes a left column and a right column; where the system further comprises a housing disposed between the left column and the right column; where the housing contains one or more actuation units; and where the one or more hydraulic hoses may be configured to connect between the one or more actuation units and the one or more hydraulic actuators. In additional system embodiments, the hydraulic hoses includes an L-shape proximate the housing and a J-shape proximate a top portion of at least one of the left and right support columns that the one or more hydraulic hoses may be disposed.

In additional system embodiments, the at least one of the first extrusion and the second extrusion further includes at least one cavity formed on the outer surfaces to receive one or more electrical lines and hydraulic lines. In additional system embodiments, the lift platform comprises: a platform assembly including an opening; one or more interchangeable inserts configured to be received in the opening of the platform assembly; and one or more engagement mechanisms configured to secure the one or more interchangeable inserts in the opening of the platform assembly.

Another system embodiment may include: a left support column; a right support column; a lift platform connected between the left support column and the right support column; a housing disposed between the left support column and the right support column; and one or more hydraulic hoses disposed at least partially within one of the left and right support columns, where the one or more hydraulic hoses may be configured to connect to one or more actuation units disposed within the housing to provide hydraulic fluid to one or more hydraulic actuators disposed within the one of the support columns.

Additional system embodiments may include: one or more batteries disposed within the housing, where the one or more batteries may be configured to provide power to the one or more actuation units; and an oil reservoir disposed within the housing, where the oil reservoir may be configured to provide hydraulic fluid to the one or more actuation units. In additional system embodiments, the one or more actuation units may be configured to provide hydraulic fluid to the one or more hydraulic actuators to raise or lower the lift platform. In additional system embodiments, the hydraulic hoses include an L-shape proximate the housing and a J-shape proximate a top portion of at least one of the left support column and right support columns that the one or more hydraulic hoses may be disposed. In additional system embodiments, at least one of the left support column and the right support column includes an assembled parallel pair of a first extrusion and a second extrusion.

A method embodiment may include: assembling a plurality of parallel extrusions to form one piece of column; connecting at least one bracket to the assembled parallel extrusions; disposing one or more first components for operating a liftgate system inside the internal space defined by the assembled parallel extrusions and disposing one or more second components for operating the liftgate system inside a housing; and connecting the housing and a lift platform to the column.

In additional method embodiments, the one or more first components include one or more actuation units, where the second components include one or more hydraulic actuators; where the method further comprises: connecting the one or more actuation units disposed inside the housing to the one or more hydraulic actuators disposed in the internal space of the assembled parallel extrusions via one or more hydraulic hoses.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1A depicts a perspective view of a liftgate system in a stowed position, mounted at a structure such as an opening at the rear of the vehicle, according to one embodiment;

FIG. 1B depicts a perspective view of a liftgate system in an unfolded position as mounted on a vehicle opening, according to one embodiment;

FIG. 1C depicts a perspective view of a liftgate system in a lowered position as mounted on a vehicle opening, according to one embodiment;

FIG. 2A to 2D depict operations of a liftgate system, according to one embodiment;

FIG. 3A depicts a flowchart of a method for assembling a liftgate system, according to one embodiment;

FIG. 3B depicts a partial exploded view of a liftgate system, showing a parallel pair of columns, mounting brackets, and a housing, according to one embodiment;

FIG. 3C depicts a partial exploded view of a liftgate system, showing a parallel pair of columns, mounting brackets, a housing, and a lift platform, according to one embodiment;

FIGS. 4A and 4B depict top perspective views of a structure of two extrusions forming a single column of a liftgate system, according to one embodiment;

FIGS. 5A to 5C depict various views of a top assembly bracket of a liftgate system, according to one embodiment;

FIGS. 6A and 6B depict various views of a single column and a mounting bracket of a liftgate system, according to one embodiment;

FIGS. 7A to 7D depict various side views of a bottom assembly bracket of a liftgate system, according to one embodiment;

FIGS. 8A and 8B depict internal spaces of a single column of a liftgate system, according to one embodiment;

FIGS. 9A to 9C depict cables, hoses, and/or other components for operating a liftgate system that run inside a column of a liftgate system, according to one embodiment;

FIG. 10A depicts a front perspective view of a liftgate with an all encompassing housing in a stowed position, according to one embodiment;

FIG. 10B depicts a rear perspective view of the liftgate of FIG. 10A, according to one embodiment;

FIG. 11 depicts a front perspective view of the liftgate of FIGS. 10A and 10B in a lowered position with covers removed from the all encompassing housing, according to one embodiment;

FIG. 12 depicts a front view of the all encompassing housing with the covers removed, according to one embodiment;

FIG. 13A depicts a perspective view of hydraulic hoses configured to connect to one or more pumps contained within the all encompassing housing and entering a right support column, according to one embodiment;

FIG. 13B depicts a perspective view of the hydraulic hoses of FIG. 13A connecting to one or more actuators disposed within the right support column for lowering and/or raising a lift platform, according to one embodiment;

FIG. 13C depicts a perspective view of the shape of the hydraulic hoses of FIGS. 13A and 13B disposed within the right support column, according to one embodiment; and

FIG. 14 depicts a bottom perspective view showing connection of hydraulic hoses between a support column and the all encompassing housing, according to one embodiment;

FIG. 15 depicts a of a liftgate system, according to one embodiment;

FIG. 16A depicts a side view of an extrusion lift platform of a liftgate system, according to one embodiment;

FIG. 16B depicts a side view of a single extruded platform segment of an extrusion lift platform, according to one embodiment;

FIG. 16C depicts a side view of two extruded platform segments connected in parallel to form an extrusion lift platform, according to one embodiment;

FIG. 17 is a perspective view of a core lift platform of a liftgate system, according to one embodiment;

FIG. 18A is a perspective view of a single honeycomb-shaped cell of a core layer of a core lift platform, according to one embodiment;

FIG. 18B depicts various materials of a honeycomb-shaped cell in a magnified view of an M portion in FIG. 18A, in accordance with embodiments of the invention.

FIG. 19 is a perspective cutaway view of a core layer of a core lift platform, which comprises a plurality of honeycomb-shaped cells, according to one embodiment;

FIG. 20 is a perspective cutaway view of a core lift platform with a core layer having a plurality of honeycomb-shaped cells, according to one embodiment;

FIG. 21 is a perspective cutaway view of a core lift platform with a core layer having a plurality of rectangular-shaped cells, according to one embodiment;

FIG. 22A is a perspective view of a grated flipover section on a lift platform, according to one embodiment;

FIG. 22B is a top view of the grated flipover section on the lift platform of FIG. 22A, according to one embodiment;

FIG. 22C is a cross-section view of the lift platform of FIG. 22B along line A-A, according to one embodiment;

FIG. 23A is a top exploded perspective view of a flipover section with multiple inserts and support plates on a lift platform, according to one embodiment;

FIG. 23B is a bottom perspective view of a flipover section with multiple inserts and support plates on a lift platform, according to one embodiment;

FIG. 24 is a top exploded perspective view of a platform section of a lift platform with spaced extruded platform segments, according to one embodiment;

FIG. 25A depicts a top perspective view of a liftgate system with alternate top insert options, according to one embodiment;

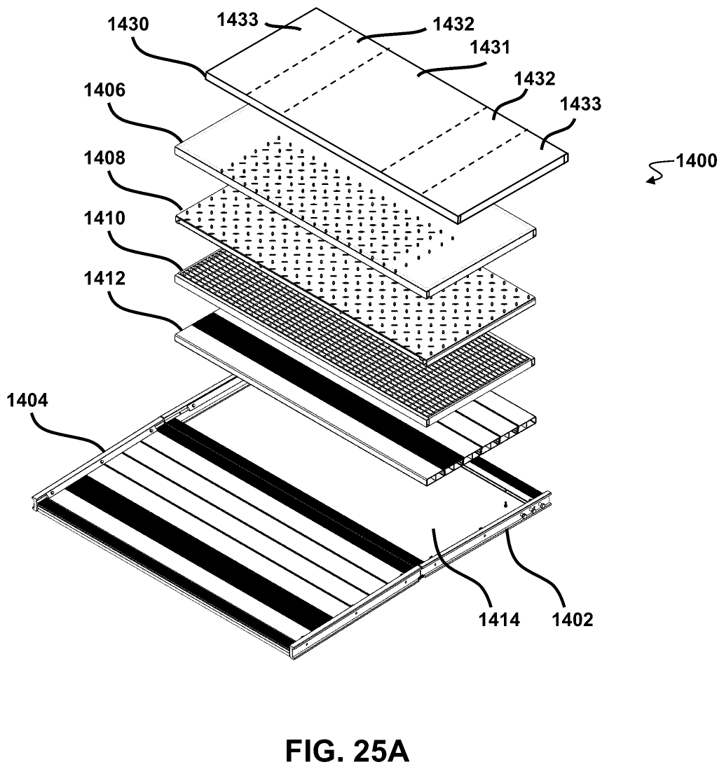

FIG. 25B depicts a bottom perspective view of the liftgate system of FIG. 25A with alternate top insert options, according to one embodiment;

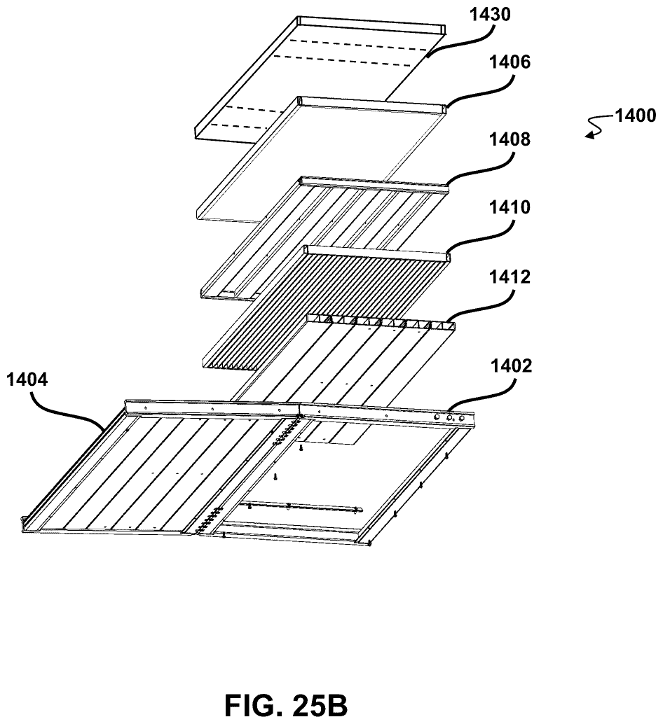

FIG. 25C depicts a top perspective view of a platform assembly for receiving an insert of FIG. 20A in a state where the platform assembly is connected to a flipover assembly, according to one embodiment;

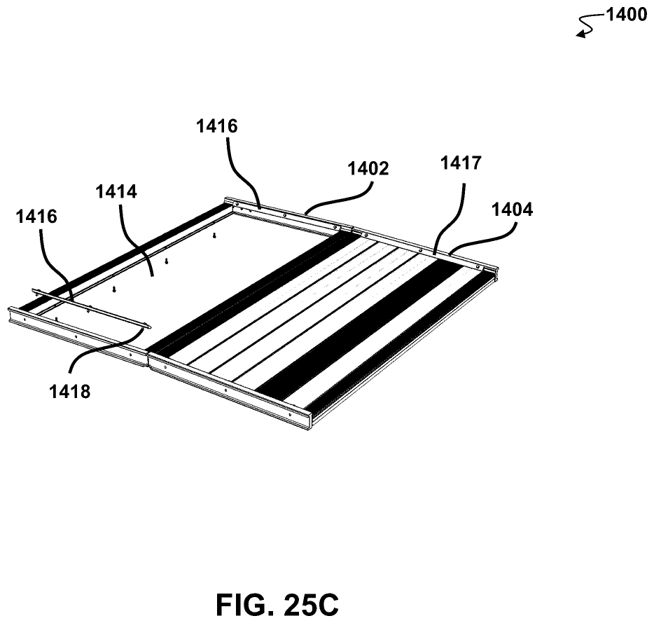

FIG. 25D depicts a bottom perspective view of the platform assembly for receiving the insert of FIG. 25A in a state where the platform assembly is connected to the flipover assembly of the liftgate system, according to one embodiment;

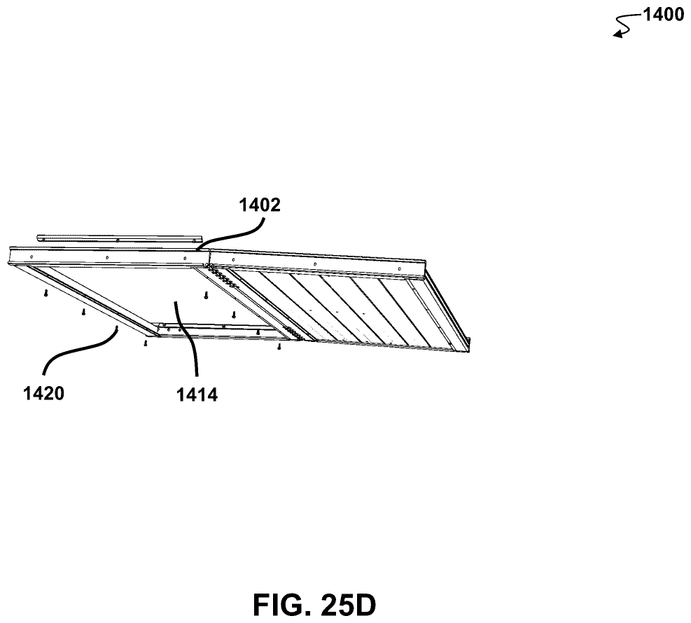

FIG. 25E depicts a top view of the platform assembly for receiving the insert of FIG. 25A in a state where the platform assembly is connected to the flipover assembly, according to one embodiment;

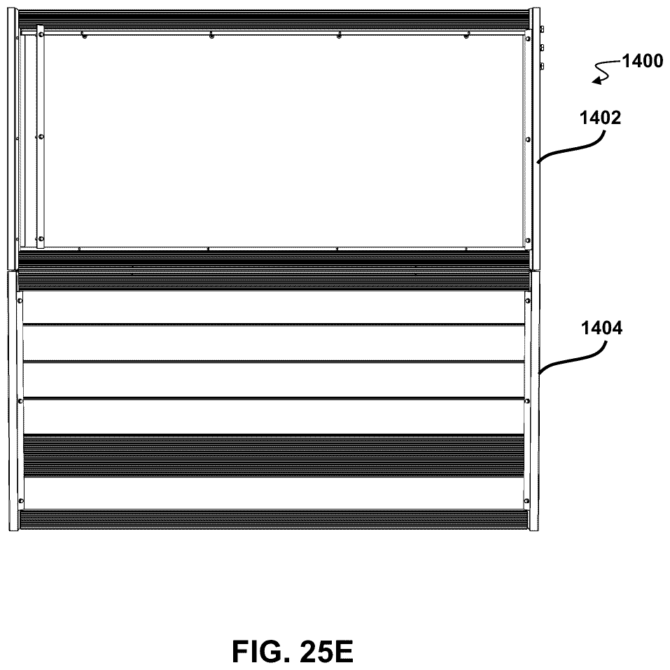

FIG. 25F depicts a flowchart of a method for assembling and utilizing a liftgate system, according to one embodiment;

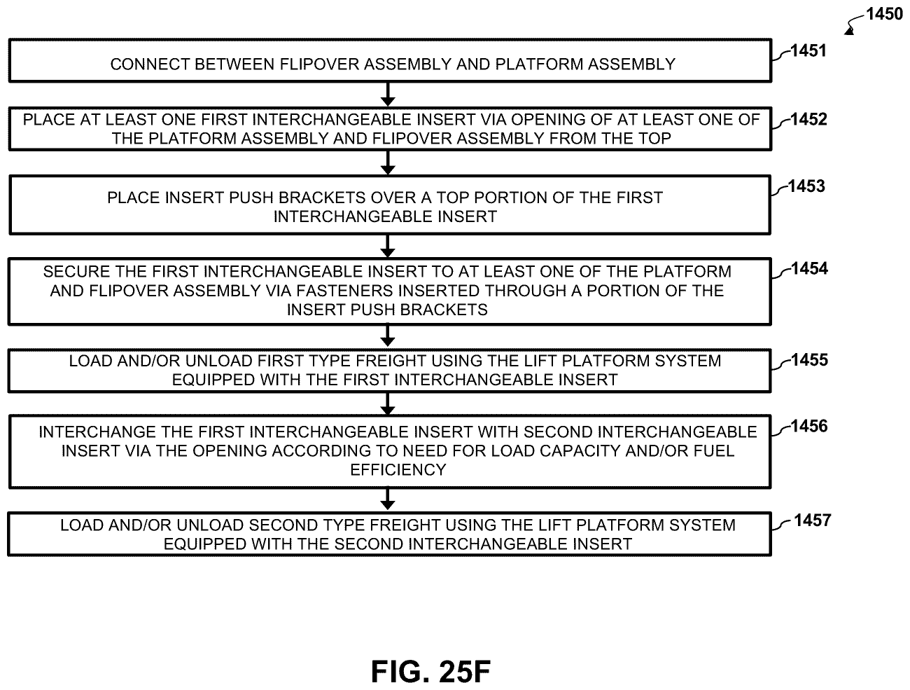

FIG. 26A depicts a top perspective view of a liftgate system with alternate side insert options, according to one embodiment;

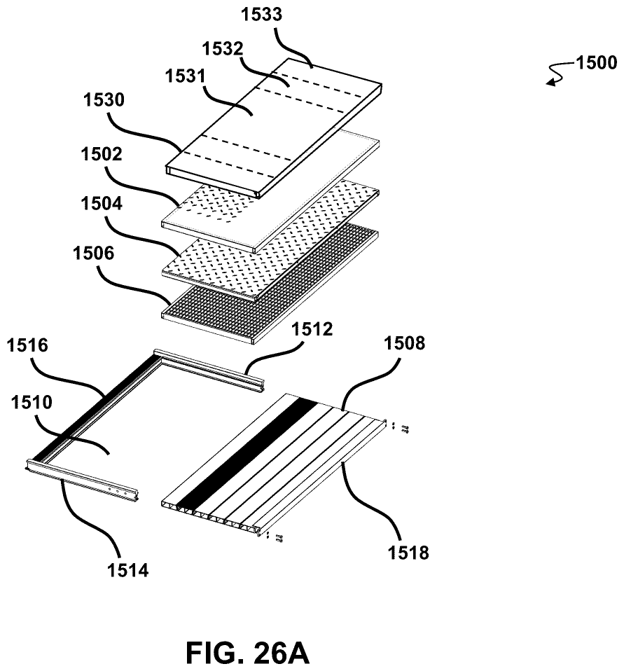

FIG. 26B depicts a bottom perspective view of the liftgate system of FIG. 26B with alternate side insert options, according to one embodiment;

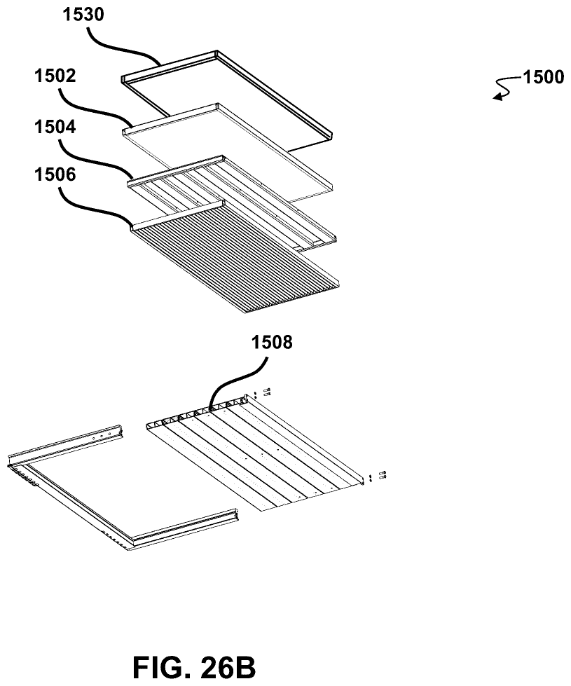

FIG. 26C depicts a top view of a platform assembly for receiving an insert of the liftgate system of FIG. 26A, according to one embodiment;

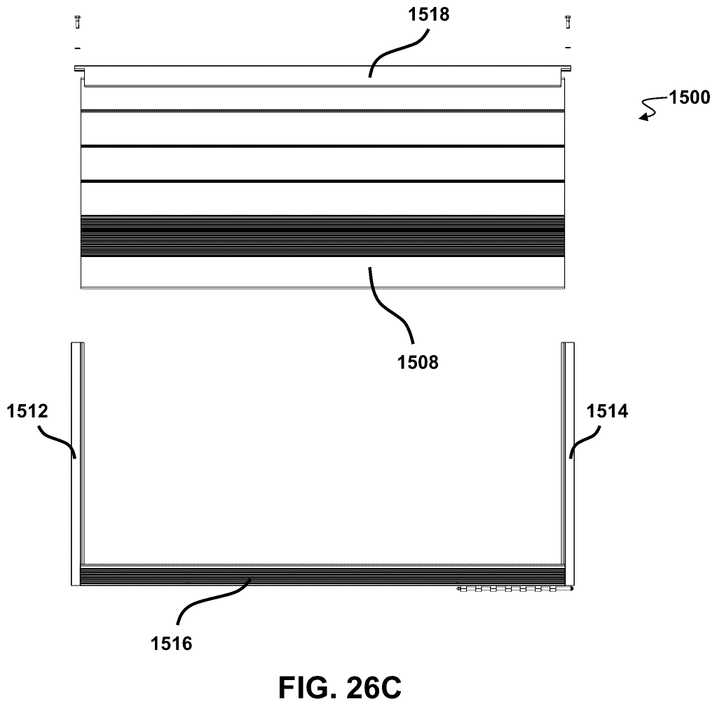

FIG. 26D depicts a bottom view of the platform assembly for receiving an insert of the liftgate system of FIG. 26A, according to one embodiment;

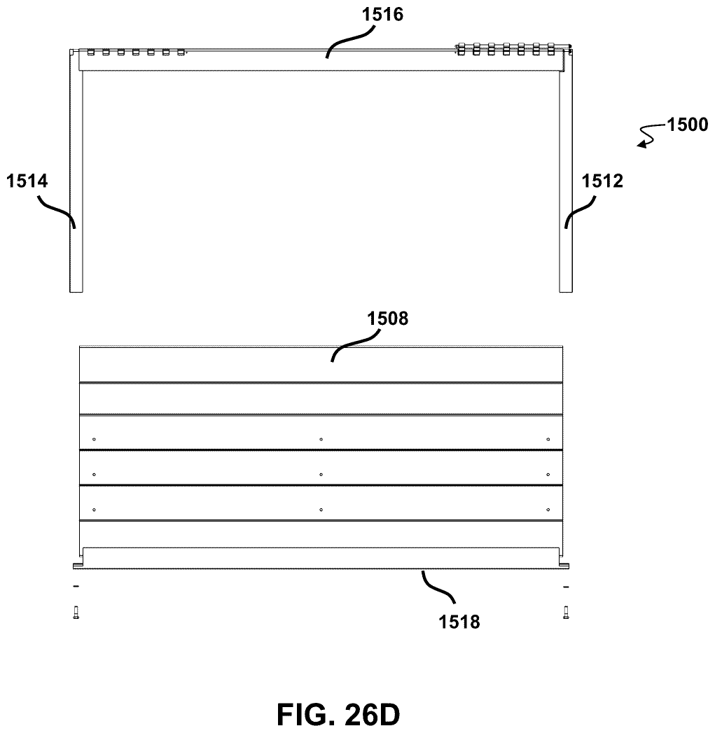

FIG. 26E depicts a flowchart of a method for assembling and utilizing a liftgate system, according to one embodiment;

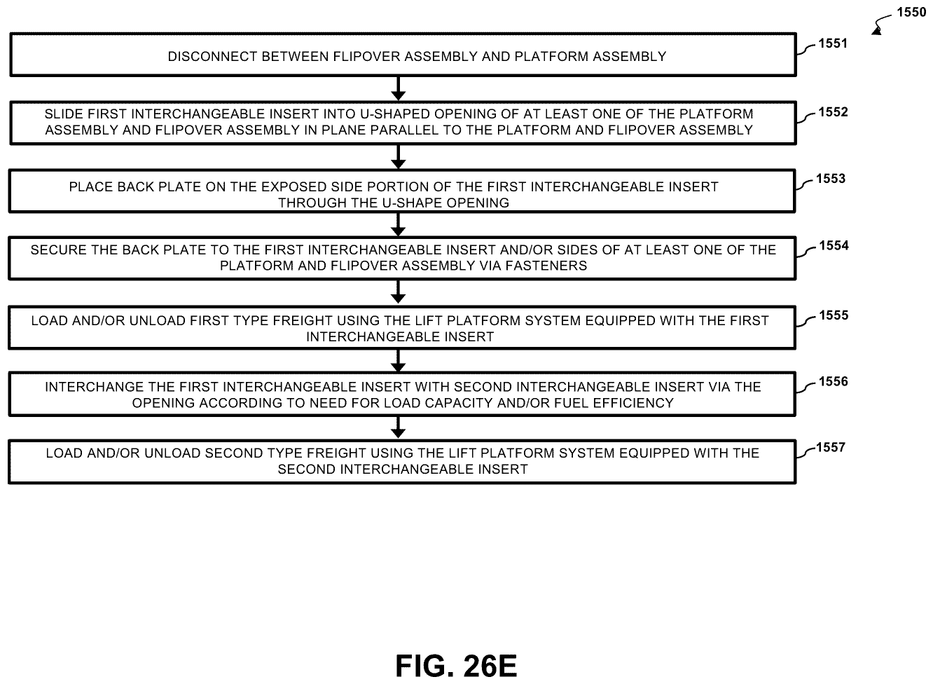

FIG. 27A depicts a top perspective view of a platform assembly for receiving an insert from the side, according to one embodiment;

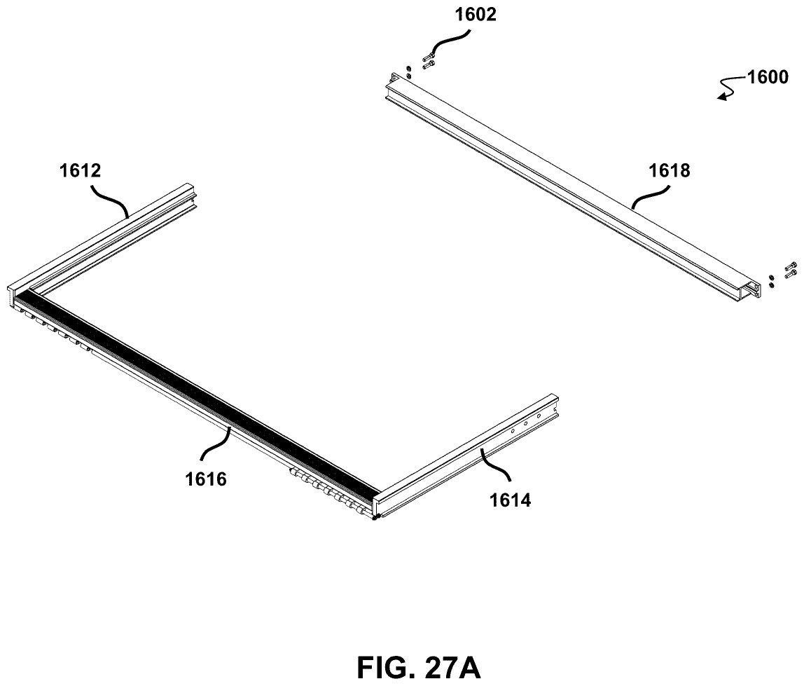

FIG. 27B depicts a top perspective view of the platform assembly for receiving an insert attached to a back plate, according to one embodiment;

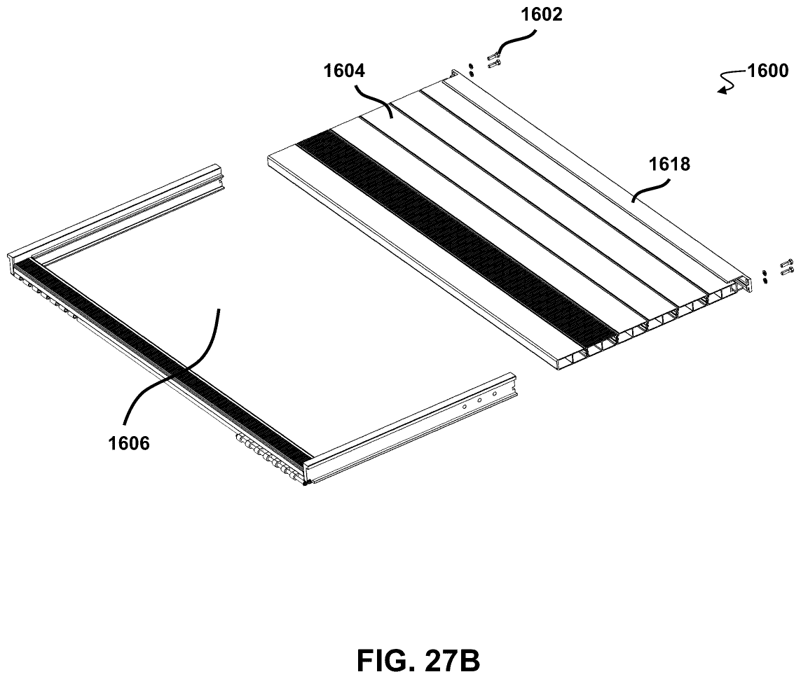

FIG. 27C depicts a top perspective view of the platform assembly for receiving the insert into the platform sides and hinge plate, according to one embodiment;

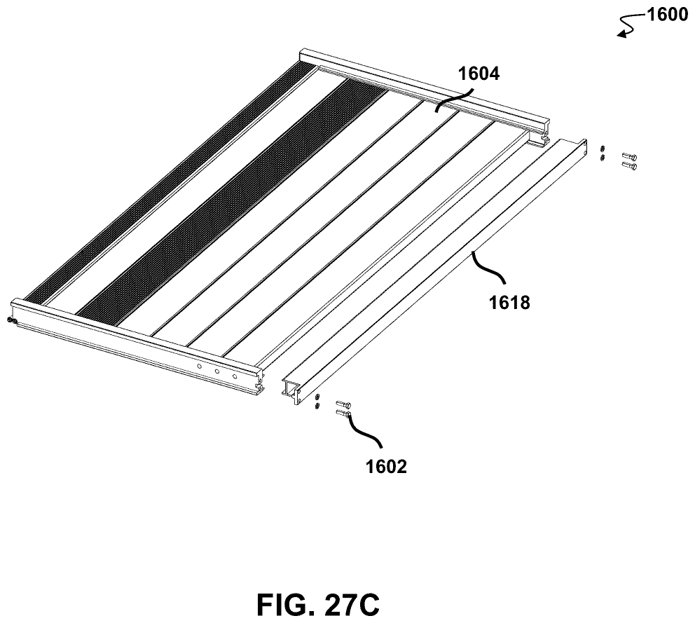

FIG. 27D depicts a top perspective view of the platform assembly with the insert inserted into the platform sides and hinge plate and secured with the back plate, according to one embodiment;

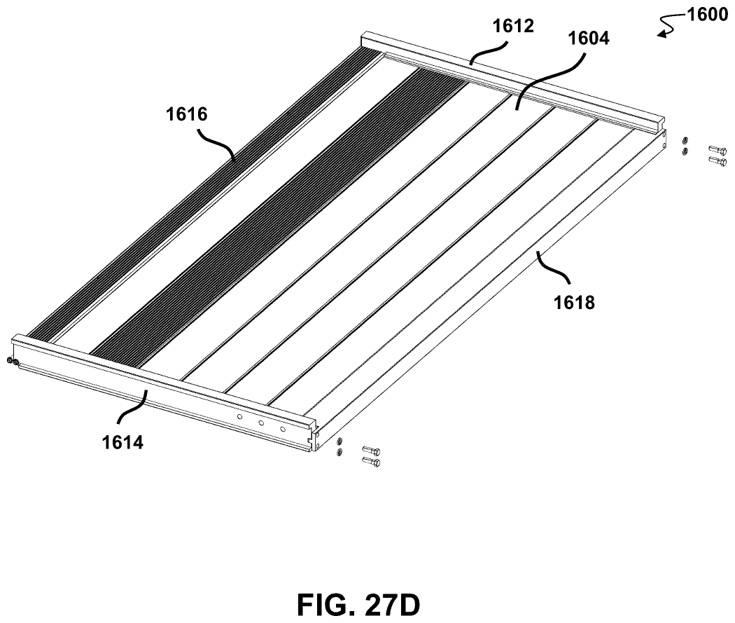

FIG. 27E depicts a close-up top perspective view of the platform assembly showing engagement mechanisms for securing the back plate to the insert, according to one embodiment;

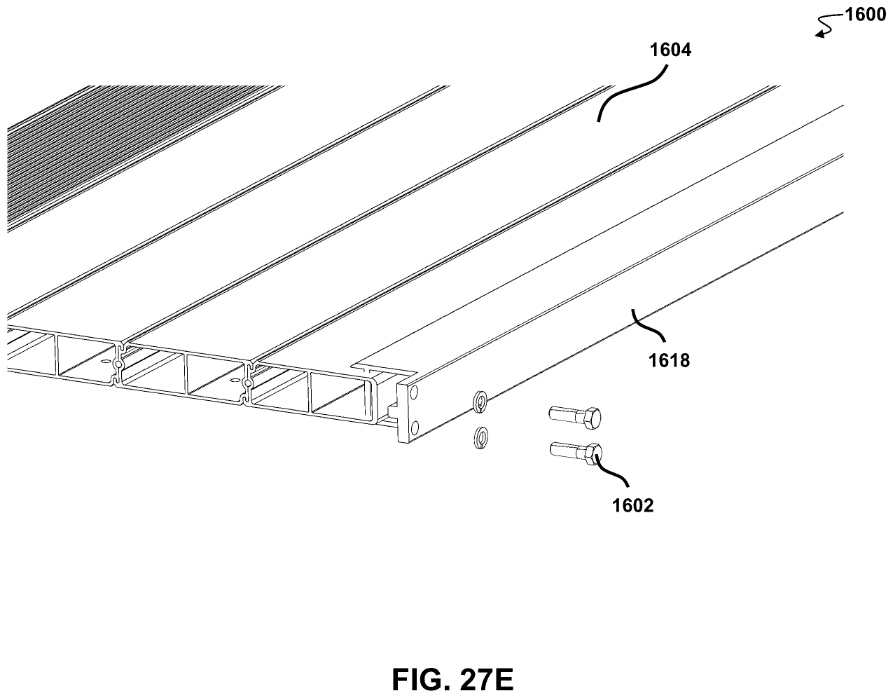

FIG. 28 depicts a close-up top perspective view of engagement mechanisms for securing the back plate to the insert and platform sides, according to one embodiment;

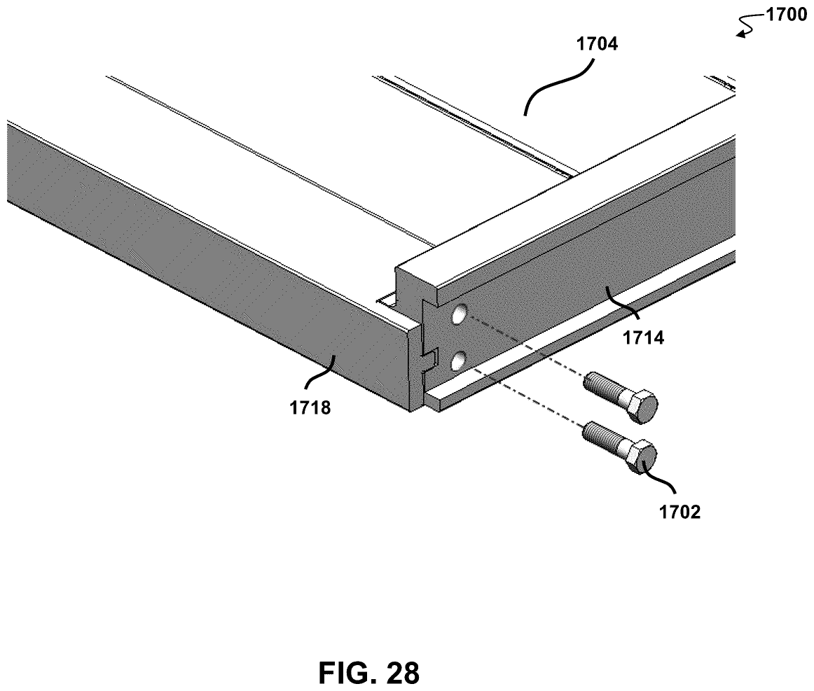

FIG. 29A depicts a top perspective view of a liftgate system having a platform connected to a flipover by a hinge, according to one embodiment;

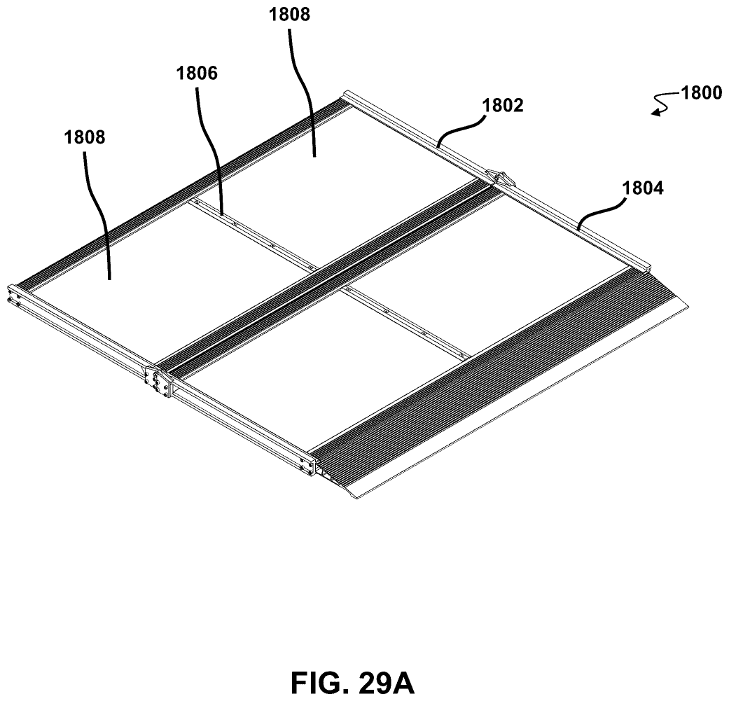

FIG. 29B depicts a bottom perspective view of the liftgate system of FIG. 29A having the platform connected to the flipover by a hinge, according to one embodiment;

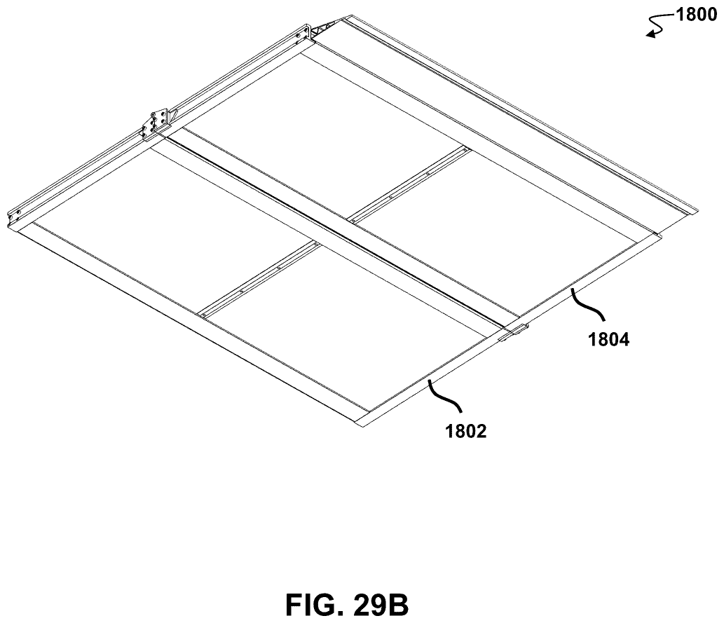

FIG. 29C depicts a top view of the liftgate system of FIG. 29A having the platform connected to the flipover by a hinge, according to one embodiment;

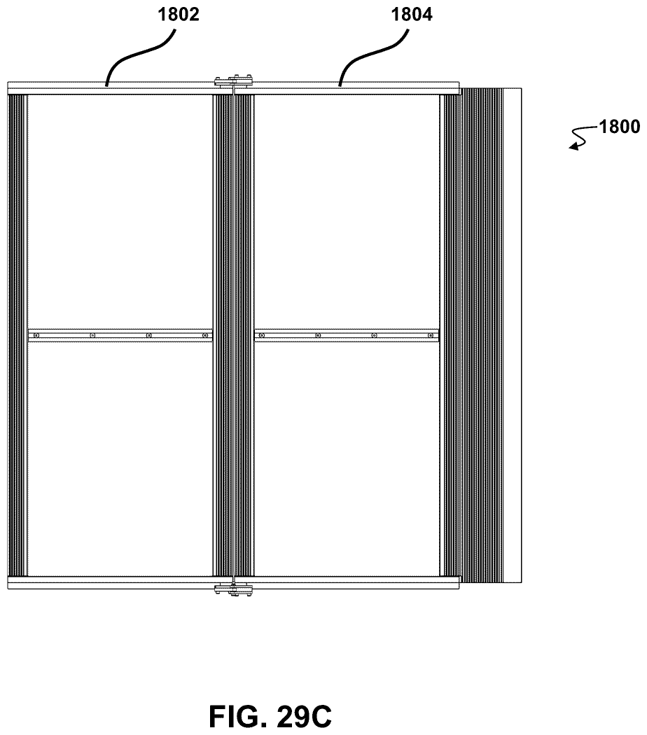

FIG. 29D depicts a bottom view of the liftgate system of FIG. 29A having the platform connected to the flipover by a hinge, according to one embodiment; and

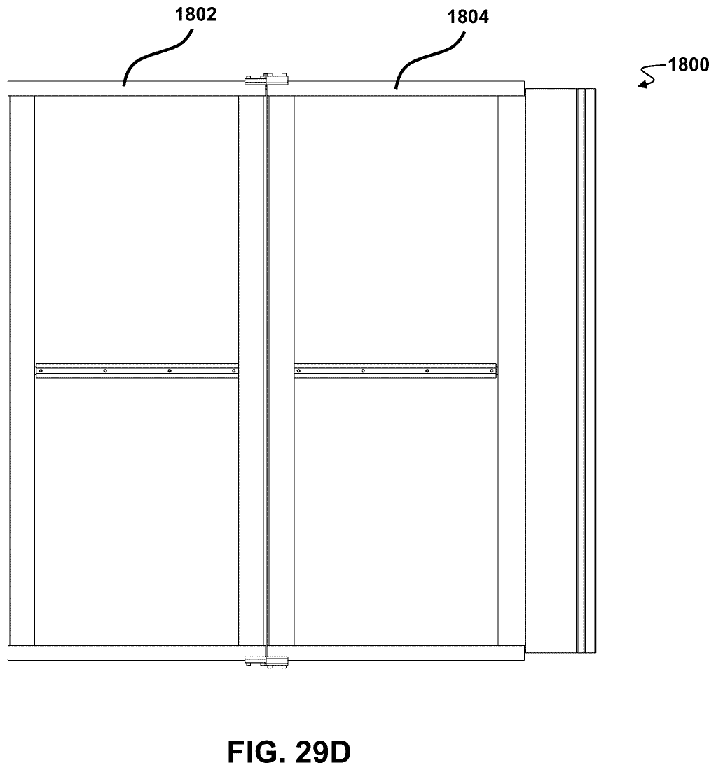

FIG. 29E depicts a side view of the liftgate system of FIG. 29A having the platform connected to the flipover by a hinge, according to one embodiment.

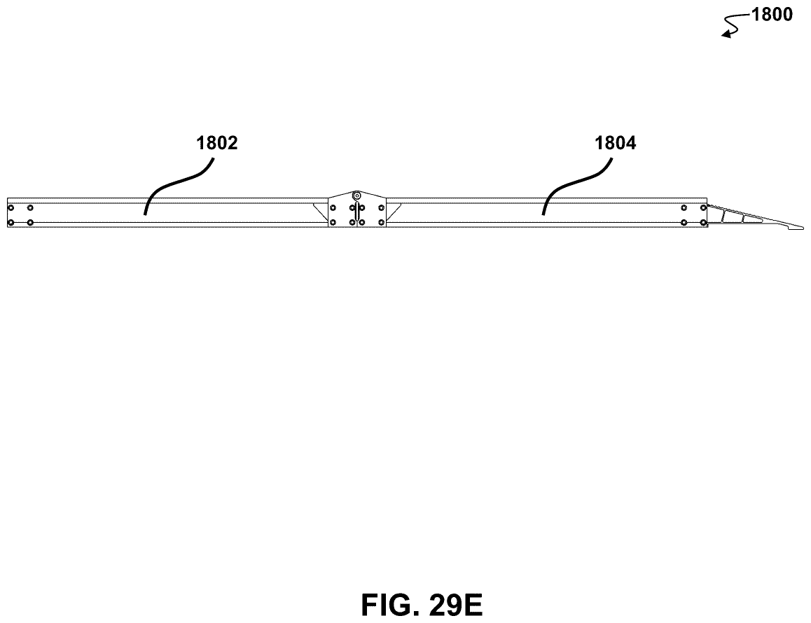

### DETAILED DESCRIPTION

The following description is made for the purpose of illustrating the general principles of the embodiments discloses herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

The present liftgate system may be a column lift style liftgate including at least one column, each including a plurality of parallel extrusions. The plurality of parallel extrusions may be assembled as one piece by at least one assembly bracket, and the assembled extrusions as a single column may form and define an internal space where one or more liftgate movement components, such as cables, hoses, and/or other components, are disposed and where a runner for raising and/or lowering a lift platform is configured to slide along. The assembly bracket may serve as both a connecting plate configured to hold and connect the plurality of extrusions together for more precise squareness and the parallelism of the internal space and an impact plate configured to absorb impacts, thus creating the stable liftgate system. Any of the components of the liftgate system disclosed herein may be made from composite.

In addition, the present system may also allow for an all encompassing lift platform. Some liftgates may require a separate mounting location for batteries, motors, valves, switches, and solenoids. This increases the complexity of a liftgate installation as these components must be installed separately from the liftgate on a truck and then connected to ensure proper operation. Batteries may be stored in a separate enclosure that may be mounted to an underside of the truck. Power from the batteries must then be routed to the liftgate from the battery enclosure. The disclosed system includes all the valves, switches, solenoids, batteries, and associated hydraulics inside of a housing. All parts needed to mechanically raise and/or lower the lift platform may be disposed within this housing. A space under the extension plate has been expanded to accommodate these additional items. The height and width of the liftgate has been increased as compared to a liftgate with distally mounted components. The housing may stay level and not move relative to a truck on which the liftgate is mounted to. One or more liftgate movement components, such as cables, hoses, and the like, may be run inside of the columns of the liftgate to provide hydraulic fluid to one or more hydraulic actuators for raising and/or lowering the lift platform of the liftgate.

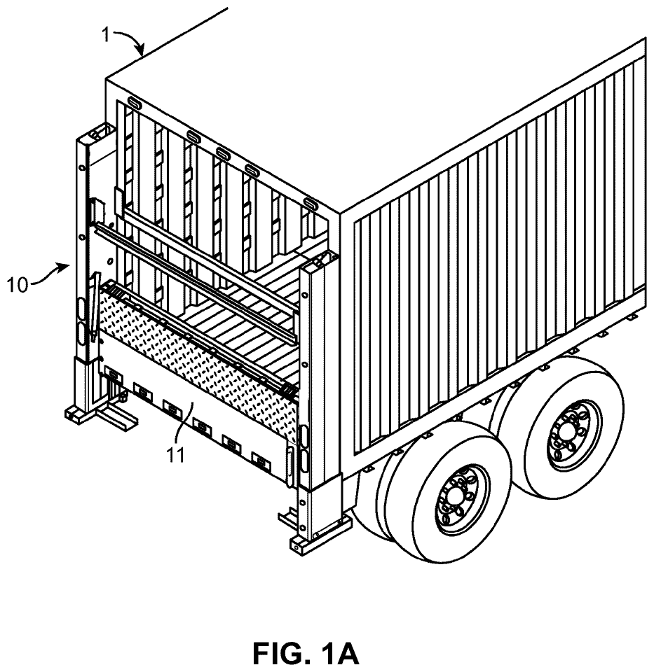

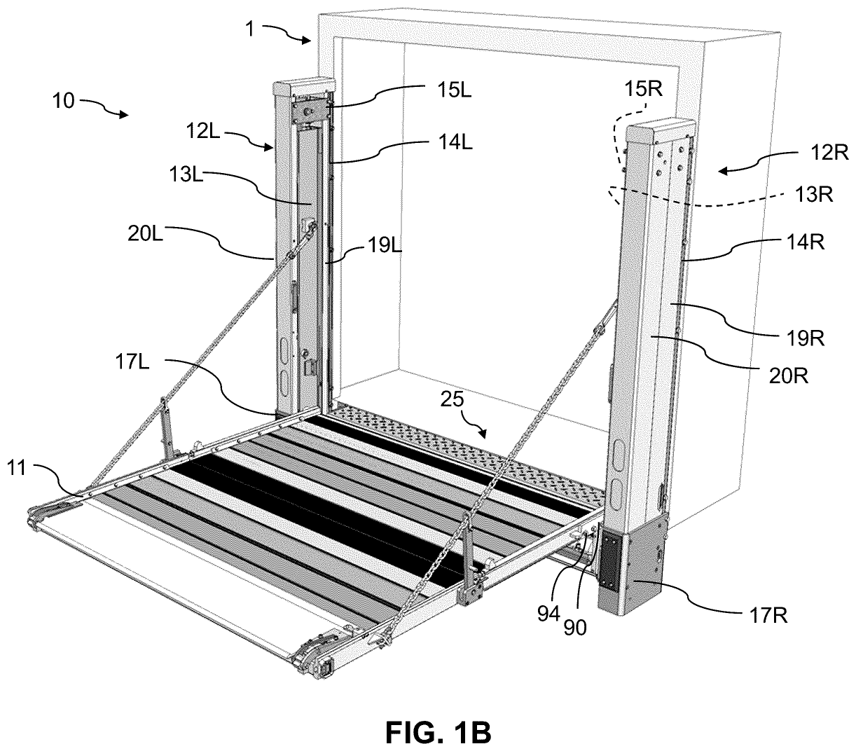

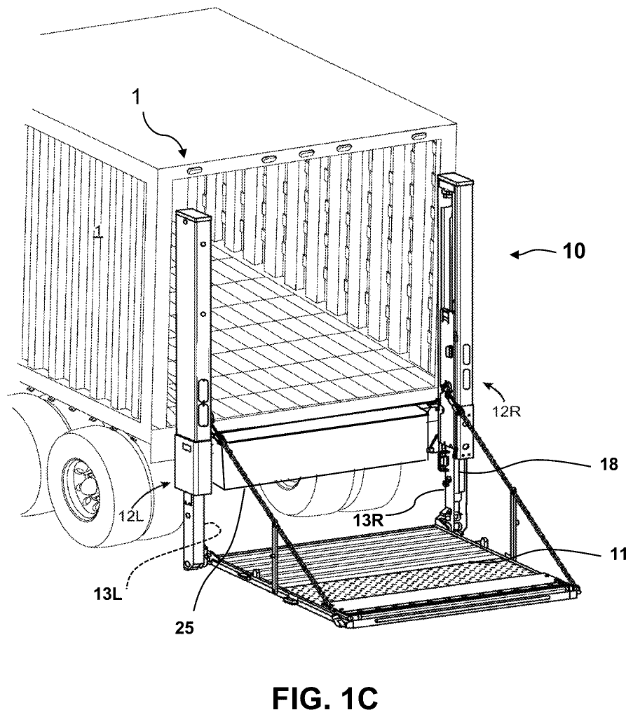

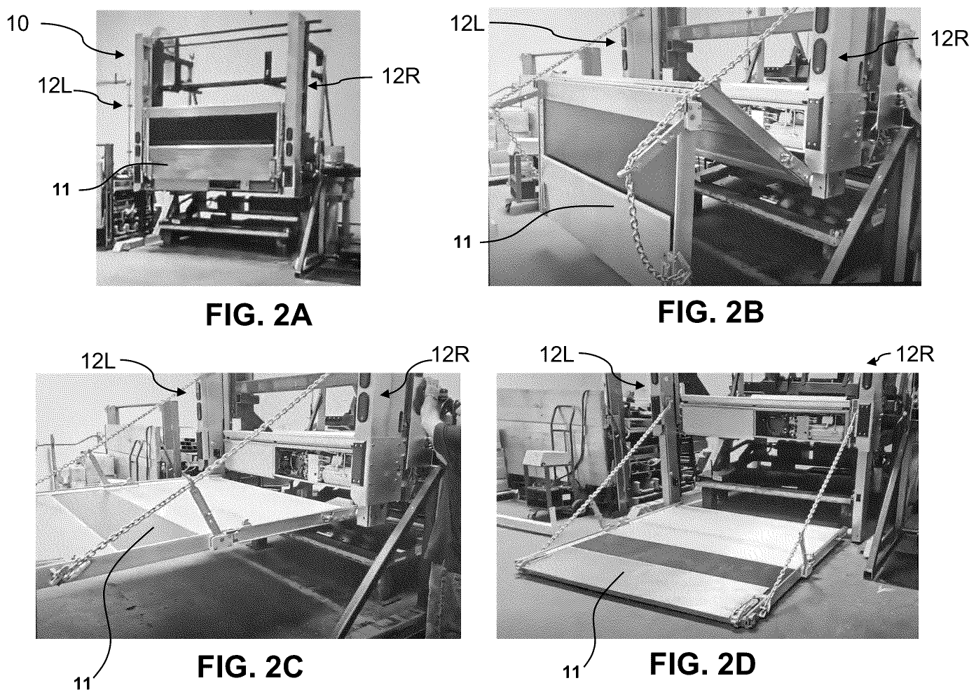

FIG. 1A depicts a perspective view of a liftgate system in a stowed position, mounted at a structure such as an opening at the rear of the vehicle, according to one embodiment. FIG. 1B depicts a perspective view of a liftgate system in an unfolded position as mounted on a vehicle opening, according to one embodiment. FIG. 1C depicts a perspective view of a liftgate system in a lowered position as mounted on a vehicle opening, according to one embodiment. Referring to FIGS. 1A to 1C, the liftgate system 10 may be mounted at a structure such as an opening at the rear of the vehicle 1 in one embodiment. The liftgate system 10 allows lifting payloads on the lift platform 11 from one level (e.g., the ground level) up to another level (e.g., the bed of the vehicle), or vice versa. The lift platform 11 may include two or more sections that are configured to be folded together to allow payloads to be raised to the bed of vehicle 1 and/or lowered to a ground. In the stowed position, the two or more sections of the lift platform 11 may be folded and locked into the columns via a pin so it does not keep swinging back and forth, and in the unfolded position, the two or more sections of the lift platform 11 may be unlocked and unfolded. The detailed operations of the lift platform 11 are shown in FIGS. 2A to 2D.

The liftgate system 10 may include a rigid H-frame having said parallel pair of upstanding left and right columns 12L, 12R and the lift platform 11 supported between the left and right columns 12L, 12R. The left and right columns 12L, 12R may contain a corresponding pair of vertically-disposed hydraulic actuators 18 (e.g., hydraulic cylinders) having runners 13R, 13L inside. In some embodiments, the support columns 12L, 12R may include the hydraulic actuators 18, and the hydraulic actuators 18 may be configured to operate the runners 13R, 13L to lower and/or raise the lift platform 11 connected to the runners 13R, 13L. The runners 13R, 13L of left and right columns 12L, 12R may be configured to slide along the left and right columns 12L, 12R to vertically raise and lower the lift platform 11. The pair of vertically-disposed hydraulic cylinders having runners 13R, 13L may be interconnected by a transverse stabilizing bar supporting the lift platform 11 actuated on each side by an actuating linkage system. The lift platform 11 may be connected to the left and right column 12L, 12R by connectors, such as via a chain, rod, or the like, configured to be actuated on each side by the actuating linkage system to fold or unfold the lift platform 11 and raised or lowered according to the vertical movements of the runners 13R, 13L.

Specifically, the present liftgate system 10 may be a column lift style liftgate including at least one column 12L (and/or 12R), each of which includes a plurality of parallel extrusions 19L, 20L (or 19R, 20R). In some embodiments, the present liftgate system 10 may comprise a left column 12L including a parallel pair of a first left extrusion 19L and a second left extrusion 20L and a right column 20L including a parallel pair of a first right extrusion 19R and a second right extrusion 20R. Each parallel pair may be assembled as one piece by at least one assembly bracket 15L, 17L (or 15R, 17R). In the above embodiment, the parallel pair of the first left extrusion 19L and the second left extrusion 20L may be connected to each other via a top assembly bracket 15L at the top and a bottom assembly bracket 17L at the bottom, and the parallel pair of the first right extrusion 19R and the second right extrusion 20R may be connected to each other via another top assembly bracket 15R at the top and another bottom assembly bracket 17R at the bottom. The assembled extrusions 19L, 20L (or 19R, 20R) as a single column 12L (or 12R) may form and define an internal space where one or more liftgate movement components, such as cables, hoses, and/or other components, are disposed and where a runner 13L (or 13R) for raising and/or lowering the lift platform 11 is configured to slide along. The liftgate system 10 may be mounted at a structure such as an opening at the rear of the vehicle 1 using at least one mounting bracket 14L (or 14R) connected to one extrusion 19L (or 19R) of the column 12L (or 12R).

The present liftgate system 10 may allow for the lift platform 11 that may be adjusted relative to an external surface so that payloads on the lift platform 11 can be lifted from one level (e.g., the ground level) up to another level (e.g., the bed of the vehicle), or vice versa. In a column lift style liftgate, a portion of the lift platform 11 may be connected to a portion of each of the column 12L, 12R by a connector, such as via a chain, rod, or the like. The connectors may be connected to the columns 12L, 12R at moveable portions of columns 12L, 12R, such as the runner 13L, 13R. In some embodiments, the present system 10 may allow for a wedge platform. As the moveable portion is lowered relative to the external surface and/or lift platform 11, the portion of the lift platform 11 may also be angled downward relative to the external surface and/or lift platform 11. As the moveable portion is raised relative to the external surface and/or lift platform 11, the portion of the lift platform 11 may also be angled upward relative to the external surface and/or platform 11. In some embodiments, the moveable portion may not move downward or upward unless the platform 11 is in contact with an external surface, such as the ground.

In some embodiments, the liftgate system 10 may include a housing 25 placed and connected between left and right columns 12L, 12R to house and encompass one or more parts and/or configurations required to mechanically raise and/or lower the liftgate system 10 (e.g., valves, switches, solenoids, batteries, and associated hydraulics, etc.). That is, one or more mechanical, hydraulic, and electrical components required to operate the liftgate system 10 may be disposed within either the internal spaces of the column 12L, 12R or the housing 25 and protected by the column 12L, 12R and assembly brackets 15L, 15R, 17L, 17R.

In some embodiments, the lift platform 11 may be connected to the bottom portion of the left runner 13L of left column 12L and the right runner 13R of right column 12R via side brackets 90 respectively connected to the left and right runners 13L, 13R. The side brackets 90 may have a shape extending in one direction, and one ends of the side brackets 90 may be pivotally connected to the bottom of the runners 13L, 13R. The other portion of the side brackets 90 may be connected to the lift platform 11 and configured to rotate the lift platform 11 between a horizontal direction for an unfolded position and a vertical direction for the stowed position. The side brackets 90 and the lift platform 11 may be connected by engaging between a first engaging member included in the side brackets 90 and a second engaging member 94 formed at a side of the lift platform 11. The first engaging member in the side brackets 90 and the second engaging member 94 may be configured to engage with each other in multiple modes to adjust a gap between a bed of the vehicle 1 and the lift platform 11. In some embodiments, the first engaging member in the side brackets 90 may include two or more apertures arranged in the one direction, and the second engaging member 94 may be two or more fasteners arranged in a direction in which the lift platform 11 extends. In this case, the multiple modes may be performed by selecting the number of engagements between the apertures and the fasteners.

FIG. 2A to 2B depict operations of a liftgate system, according to one embodiment. In operation, when the lift platform 11 is raised to the vehicle bed of vehicle 1, there is substantially continuous surface from the vehicle bed to the lift platform 11 to ease movement of loads between the vehicle bed and the lift platform 11. The vehicle 1 may be a truck with a rear opening, suitable for installing the liftgate system 10. In one embodiment, the liftgate system 10 may comprise a load elevator in the form of a liftgate. The liftgate system 10 may provide a dual lift system including a parallel pair of vertically extending columns 12L, 12R, each having a vertically-disposed hydraulic cylinder for vertically raising and lowering the lift platform 11 with a load carried by the pair of cylinders.

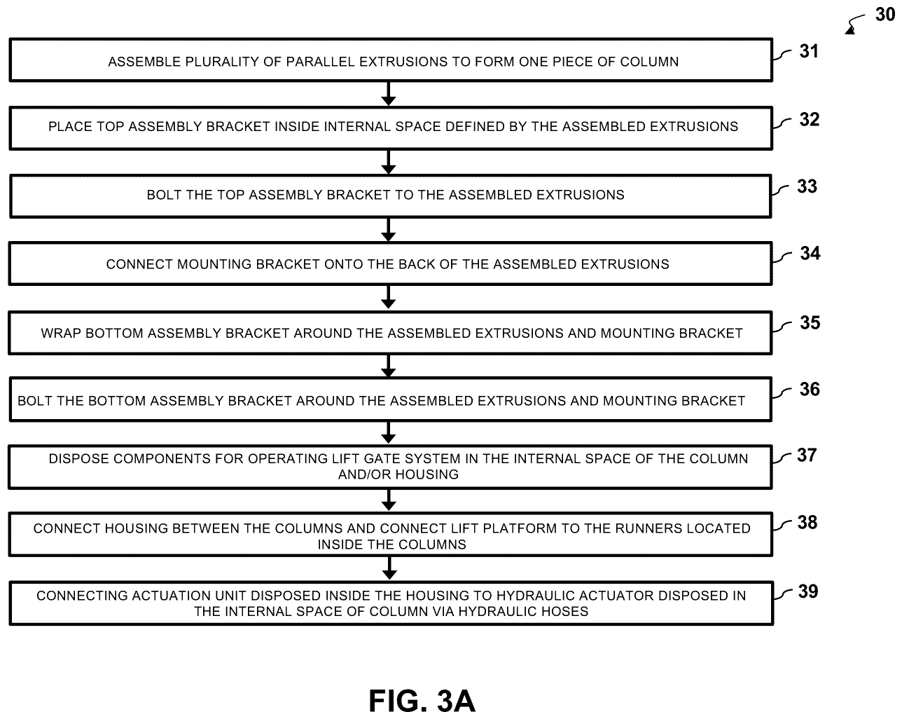

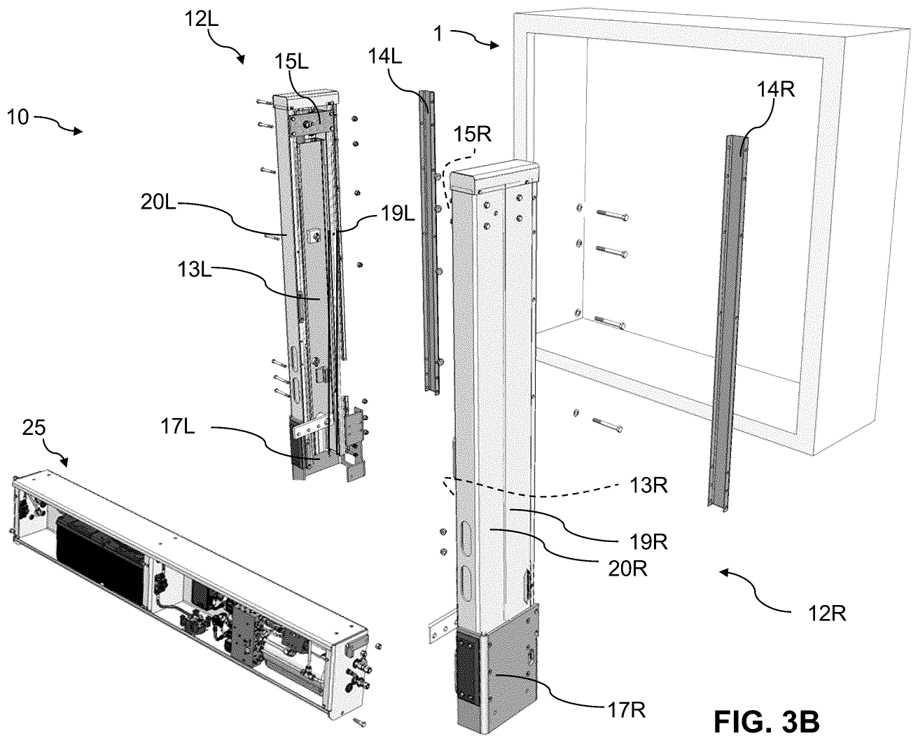

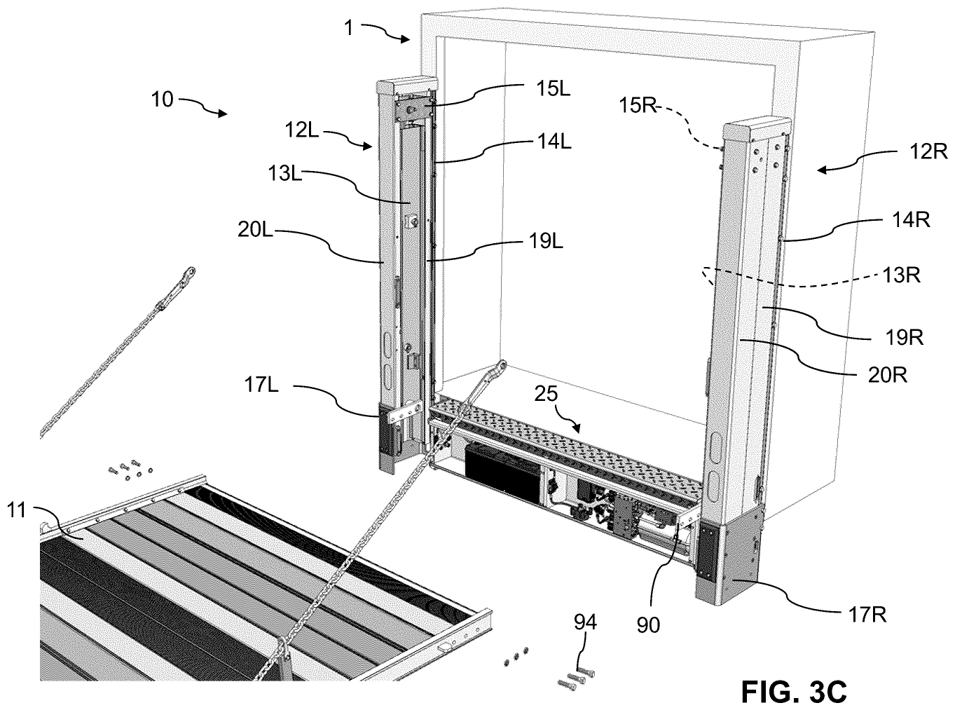

FIG. 3A depicts a schematic flowchart of a method for assembling a liftgate system, according to one embodiment. Referring to FIG. 3A, the method 30 for assembling a liftgate system may include the steps of: assembling a plurality of parallel extrusions to form a column (step 31); placing a top assembly bracket inside an internal space defined by the assembled parallel extrusions (step 32); bolting the top assembly bracket to the assembled extrusions (step 33); connecting a mounting bracket onto the back of the assembled extrusions (step 34); wrapping a bottom assembly bracket around the assembled extrusions and mounting bracket (step 35); bolting the bottom assembly bracket around the assembled extrusions and mounting bracket (step 36); disposing one or more first components for operating a liftgate system (e.g. hydraulic actuators, hydraulic components, runners, hydraulic hoses, and others) inside the internal space defined by the assembled parallel extrusions and disposing one or more second components for operating a liftgate system (e.g., actuation units, batteries, switch, motor block, oil reservoir, and others) inside a housing (step 37); connecting a housing between the columns and connecting a lift platform to the runners located inside the columns (step 38).

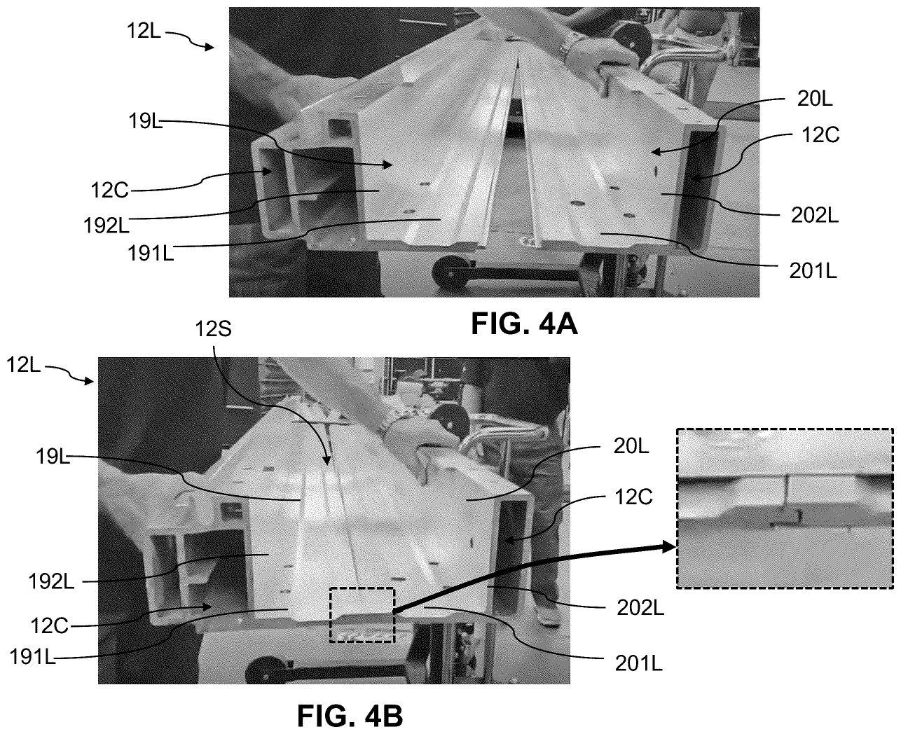

FIG. 3B depicts a partial exploded view of a liftgate system, showing a parallel pair of columns, mounting brackets, and a housing, according to one embodiment. FIG. 3C depicts a partial exploded view of a liftgate system, showing a parallel pair of columns, mounting brackets, a housing, and a lift platform, according to one embodiment. FIGS. 4A and 4B depict a structure of two extrusions forming a single column of a liftgate system, according to one embodiment. Referring to FIGS. 3A to 4B, the present liftgate system 10 may comprise a left column 12L including a parallel pair of a first left extrusion 19L and a second left extrusion 20L and a right column 20L including a parallel pair of a first right extrusion 19R and a second right extrusion 20R. As shown in FIGS. 4A and 4B, each of the first and second left extrusion 19L, 20L for the left column 12L may have an L-shape, and the assembled parallel pair of the first and second left extrusion 19L, 20L may have a C-shape defining an internal space 12C where one or more liftgate movement components, such as cables, hoses, and/or other components, are disposed and where a runner for raising and/or lowering a lift platform is configured to slide along. The one or more liftgate movement components, such as cables, hoses, and the like, may be run through the internal space 12C of the column 12L of the liftgate system 10 to provide hydraulic fluid to one or more hydraulic actuators for raising and/or lowering the lift platform 11. The right column 12R may also be the same as or similar structure to the left column 12L, and thus, the detailed description for the right column 12R will be omitted to avoid redundancy.

Specifically, as shown in FIGS. 4A and 4B, the first left extrusion 19L may have a first extending portion 191L and a second extending portion 192L perpendicular to the first extending portion 191L. Likewise, the second left extrusion 20L may have a first extending portion 201L and a second extending portion 202L perpendicular to the first extending portion 201L. The first extending portion 191L of the first left extrusion 19L and the first extending portion 201L of the second left extrusion 20L may be arranged to extend in the same plane. In this case, the first extending portion 191L of the first left extrusion 19L and the first extending portion 201L of the second left extrusion 20L may be arranged in such a way that the end of the first extending portion 191L of the first left extrusion 19L and the end of the first extending portion 201L of the second left extrusion 20L may be in contact with each other. In some embodiments, the end of the first extending portion 191L of the first left extrusion 19L may have a groove and/or tongue that is engaged with a tongue and/or groove formed at the end of the first extending portion 201L of the second left extrusion 20L.

According to the arrangement where the first extending portion 191L of the first left extrusion 19L and the first extending portion 201L of the second left extrusion 20L are extend in the same plane, the surfaces of the second extending portion 192L of the first left extrusion 19L and the second extending portion 202L of the second left extrusion 20L may be arranged to face each other and extended in a precise parallel direction. The internal space 12S may be defined by the first extending portion 191L of the first left extrusion 19L and the first extending portion 201L of the second left extrusion 20L as an assembled bottom surface and the second extending portion 192L of the first left extrusion 19L and the second extending portion 202L of the second left extrusion 20L as both side surfaces. The precise parallel side surfaces of the internal space 12C enable the stable running motion of the runners 13L, 13R when it slides along the internal space 12C to raise and/or lower the lift platform 11. Accordingly, payloads on the lift platform 11 can be stably lifted from one level (e.g., the ground level) up to another level (e.g., the bed of the vehicle), or vice versa.

A column extruded as a single extrusion or welded from a plurality of extrusions may experience manufacturing issues related to warpage or twisting as well as limitations in a size. In other words, these columns with warpage or twisting have trouble holding the squareness and the parallelism of the two surfaces of the internal space, cause unstable running motion of runners in a column lift style liftgate, and degrade the quality of lifting payloads. On the other hand, according to the present system, the column 12L formed by the assembled extrusions 19L, 20L eliminates those potential quality problems caused by a single extrusion and welded extrusions and also eliminates the time for a welding process. In addition, while conventional systems are equipped with clamping and other additional components to receive or house operating components for lifting, the internal space 12S formed by the plurality of extrusions 19L, 20L of the present system allow the placement of runners 13L, hydraulic components for operating the runners 13L, and other components (e.g. brackets, bars, etc.) that slide inside the column 12L.

In some embodiments, at least one of the first left extrusion 19L and the second left extrusion 20L may further include a cavity formed on the outer surface to receive electrical lines and/or hydraulic lines. In some embodiments, additional brackets may be disposed in the cavity. In some embodiments, the cavity of the first left extrusion 19L and the second left extrusion 20L may be formed via extrusion. In some embodiments, the at least one of the first left extrusion 19L and the second left extrusion 20L may be made of metal, such as aluminum, steel, etc.

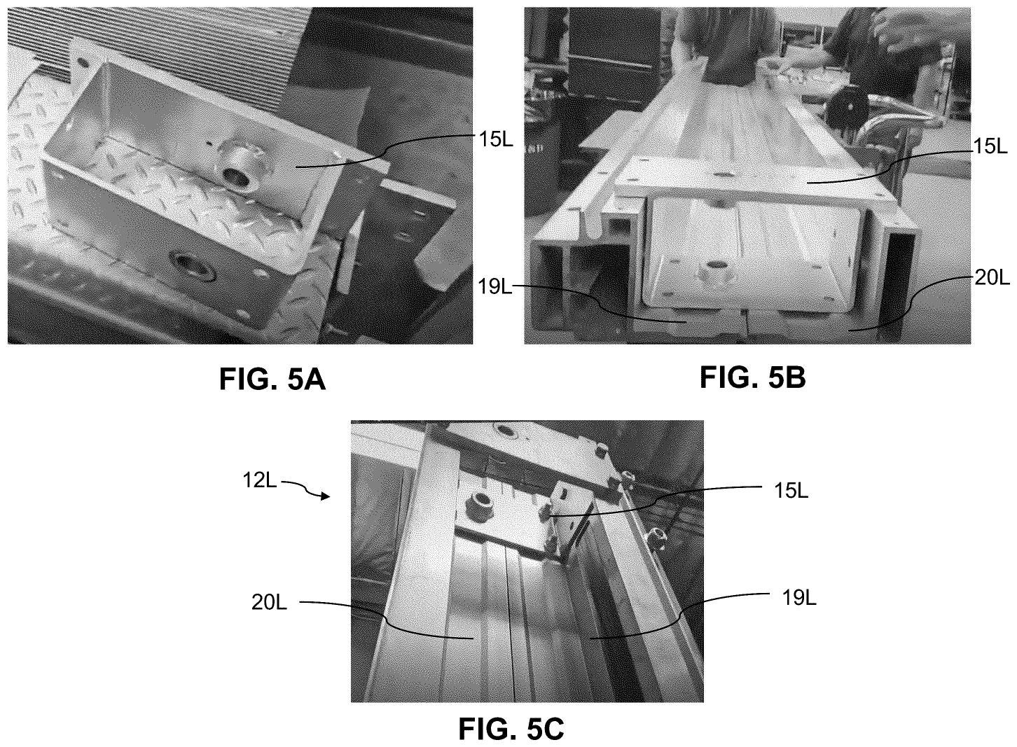

FIGS. 5A to 5C depict a structure of a top assembly bracket of a liftgate system, according to one embodiment. Referring to FIGS. 3A to 5C, the assembled parallel pair of the first left extrusion 19L and the second left extrusion 20L may be fixed together at the top via a top assembly bracket 15L located inside the internal space 12C. The top assembly bracket 15L may have a four-sided polygon shape that fits the internal space 12C and configured to hold the assembled parallel pair of the first left extrusion 19L and the second left extrusion 20L, not to twist. The assembled parallel pair of the first left extrusion 19L and the second left extrusion 20L may be bolted together with the top assembly bracket 15L, preventing warpage or twisting caused by welding. Accordingly, the top assembly bracket 15L may serve as an assembly bracket that is configured to hold and connect together the assembled parallel pair of the first and second left extrusion 19L, 20L, a multifunctional cylinder mount that is configured to hold a cylinder, and an impact plate that is configured to absorb impacts. In some embodiments, the four-sided polygon shape of the top assembly bracket 15L may be weldment. In some embodiments, the internal space 12C may further contain a plurality of brackets disposed inside the internal space 12C.

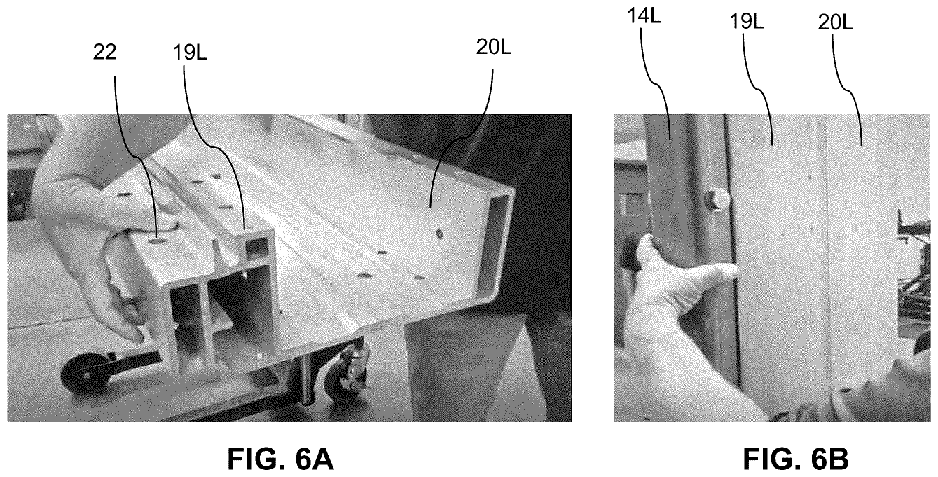

FIGS. 6A and 6B depict structures of a single column and a mounting bracket of a liftgate system, according to one embodiment. Referring to FIGS. 3A to 3C, 6A and 6B, the back of the assembled parallel pair of the first left extrusion 19L and the second left extrusion 20L may be connected to a mounting bracket 14L. The mounting bracket 14L may be configured to mount the liftgate system 10 to the vehicle 1. Specifically, one of the assembled parallel pair of the first left extrusion 19L and the second left extrusion 20L, which is located in the back of the column 12L (e.g. the first left extrusion 19L), may be extruded with a hole 22 to accept the cross drilling mounting. The mounting bracket 14L may be extruded to have a columnar shape that is extended along the column 12L and bolted with the back of the first left extrusion 19L without welding. In some embodiments, the mounting bracket 14L may be made of metal, such as steel and may be allowed to be welded to the vehicle 1.

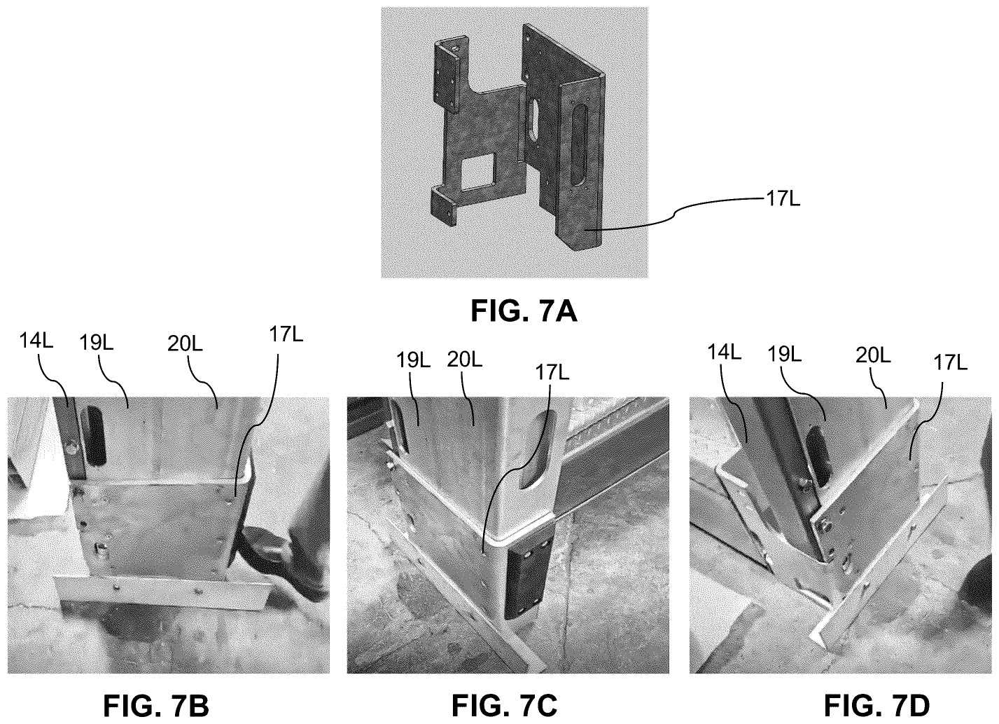

FIGS. 7A to 7D depict a structure of a bottom assembly bracket of a liftgate system, according to one embodiment. Referring to FIGS. 3A to 3C, 6A to 7D, the assembled parallel pair of the first left extrusion 19L and the second left extrusion 20L with the mounting bracket 14L may be fixed together at the bottom via a bottom assembly bracket 17L located outside the assembled parallel pair and the mounting bracket 14L. In some embodiments, the bottom assembly bracket 17L may have a three-sided polygon shape that fittingly surrounds or wraps around the outside of the assembled parallel pair and the mounting bracket 14L and configured to hold the assembled parallel pair of the first left extrusion 19L and the second left extrusion 20L, not to twist. In some embodiments, the assembled parallel pair of the first left extrusion 19L and the second left extrusion 20L with the mounting bracket 14L may be bolted together without welding. The bottom assembly bracket 17L may also serve as an impact plate that is configured to absorb impacts. The bottom assembly bracket 17L may also be configured to connect all components together, such as the column 12L, a housing 25, and other components. In some embodiments, the bottom assembly bracket 17L may optionally be bolted to the rear of the vehicle 1.

These top and bottom assembly brackets 15L, 17L may fix together the assembled parallel pair of the first left extrusion 19L and the second left extrusion 20L as one piece, making sure that the first portion 191L and the second portion 192L of the first left extrusion 19L are perpendicular to each other, that the first portion 201L and the second portion 202L of the second left extrusion 20L are perpendicular to each other, and that the second portion 192L of the first left extrusion 19L and the second portion 202L of the second left extrusion 20L are parallel all the way along, not twisted. That is, unlike systems manufactured using a welding process, these top and bottom assembly brackets 15L, 17L may further ensure the quality of the squareness and the parallelism of the assembled bottom surface (191L, 201L, FIGS. 4A and 4B) and two side surfaces (192L, 202L, FIGS. 4A and 4B) of the internal space 12C. Accordingly, the consistency of running, sliding, and/or rolling of the internal components (e.g., runner 13L) along these two surfaces can be maintained.

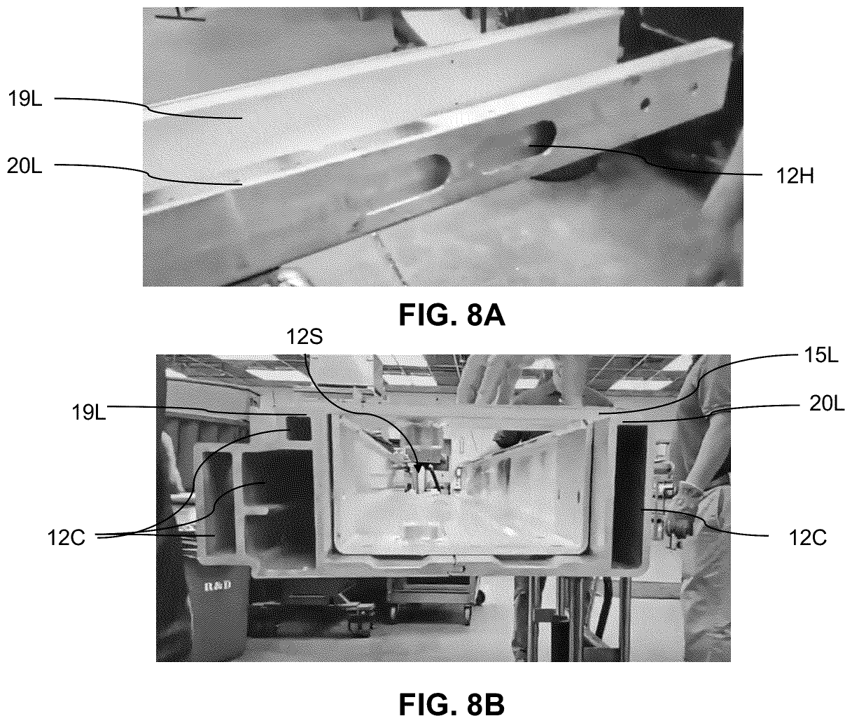

FIGS. 8A and 8B depict structures of internal spaces of a single column of a liftgate system, according to one embodiment. Referring to FIGS. 3A to 4B, 8A and 8B, one of the assembled parallel pair of the first and second left extrusion 19L, 20L, which is located in the front of the column 12L (e.g. the second left extrusion 20L), may further include at least one cavity 12C extended along the longitudinal direction of the column 12L and at least one hole 12H formed on the front of the column 12L for mounting a lamp. The hole 12H may be configured to communicate with the cavity 12C, and electrical lines for the lamp may be disposed inside the cavity 12C.

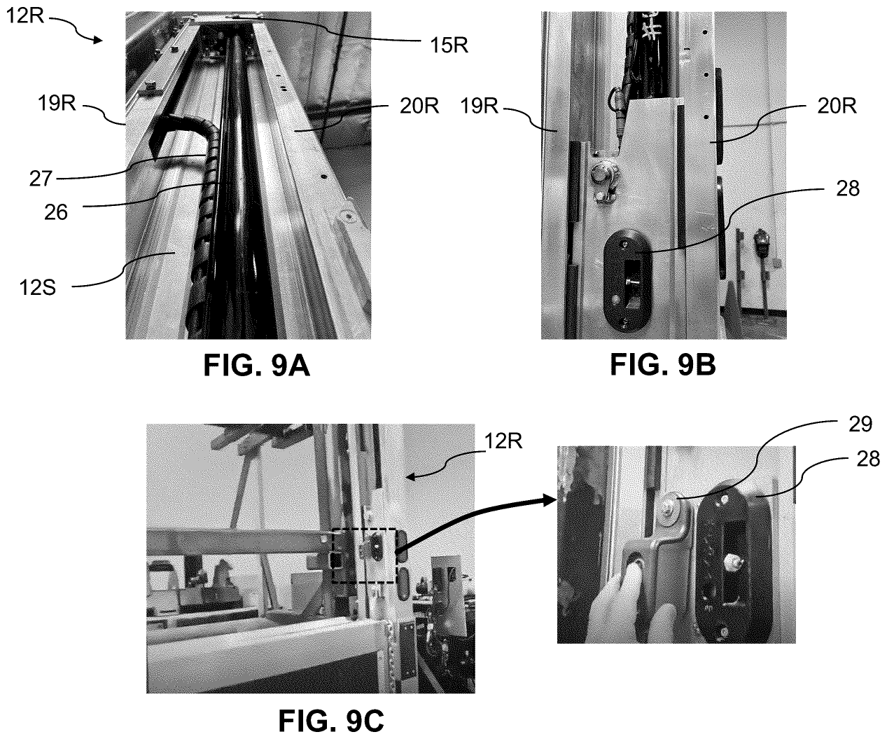

FIGS. 9A to 9C depict one or more liftgate movement components, such as cables, hoses, and/or other components, for operating a liftgate system that run inside a column of a liftgate system, according to one embodiment. Referring to FIGS. 3A to 3C, 9A to 9C, the internal space of the right column 12R formed by the assembled parallel pair of the first and second left extrusion 19R, 20R may contain hydraulic components 26, 27 (e.g., hydraulic actuators, hydraulic cylinder, related hoses and lines, and others) for raising and lowering the lift platform 11. Accordingly, unlike conventional systems, the portion of the hydraulic actuators (e.g., the hydraulic cylinder) and/or related lines 26, 27 may be mounted and held on the top assembly bracket 15R which is located at the top of the liftgate system 10, and thus the hydraulic components 26, 27 may be located above the housing 25 or the bed of the vehicle 1. Thus, even when the vehicle 1 with the liftgate system 10 goes down the road, the liftgate system 10 including hydraulic cylinders can be positioned higher away from debris. In addition, the hydraulic actuators (e.g., the hydraulic cylinder) and/or related lines 26, 27 located at the upper level of the liftgate system 10 also allows for a neater routing of the hoses, more space, and more bending radius for the hoses. In some embodiments, the components for operating a liftgate system 10 that are disposed in the internal space of the right column 12R may include any parts other than those used for raising and/or lowering a lift platform 11.

In some embodiments, the hydraulic hoses may connect between one or more pumps contained within the housing 25 and one or more actuators disposed within the right column 12R for lowering and/or raising the lift platform 11. The hydraulic hoses may be routed through the column 12R to provide any needed slack throughout all movements of the liftgate system 10. While the right column 12R is shown in FIGS. 9A to 9C, one or more hydraulic hoses may be disposed in the left column 12L. The housing 25 containing actuation units (e.g., pump) and one or more columns 12R, 12L containing hydraulic hoses allow for movement of the lift platform system 10 without impinging the one or more hydraulic hoses 82, 84.

The right column 12R may further include at least one switch 28, 29 configured to operate the hydraulic components 26, 27. In some embodiments, the switch 28, 29 may be operated wirelessly for remote control. The switch 28, 29 may send a wireless signal to a power unit to raise and/or lower the lift platform 11. This wireless configuration may eliminate a moving wire connected to the switch 28, 29 and thus prevent malfunction of switching operations caused by damage of the wire due to its movements and other wires and/or lines. In some embodiments, any one of the switches 28, 29 with wireless configuration may be connected to a battery.

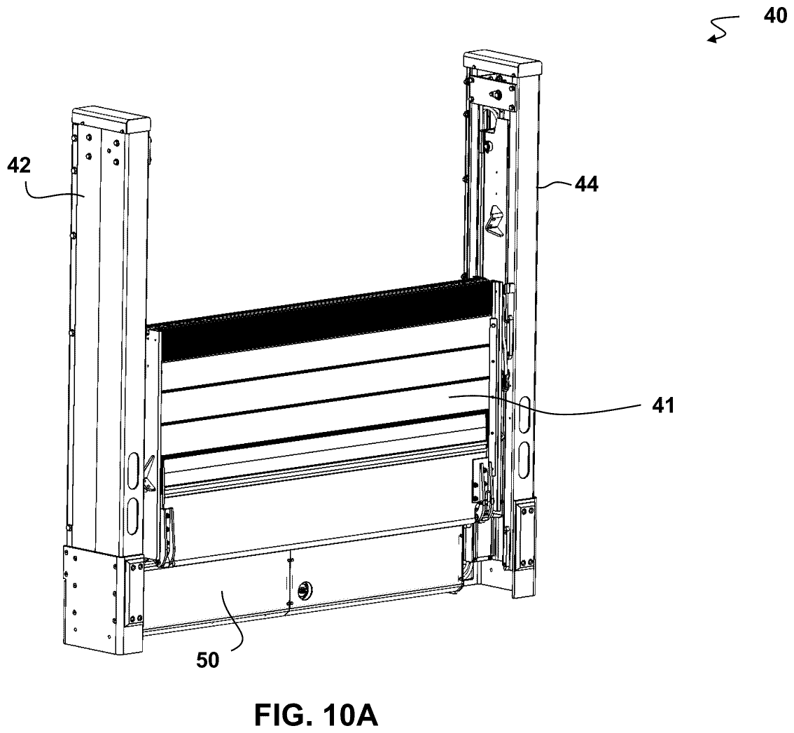

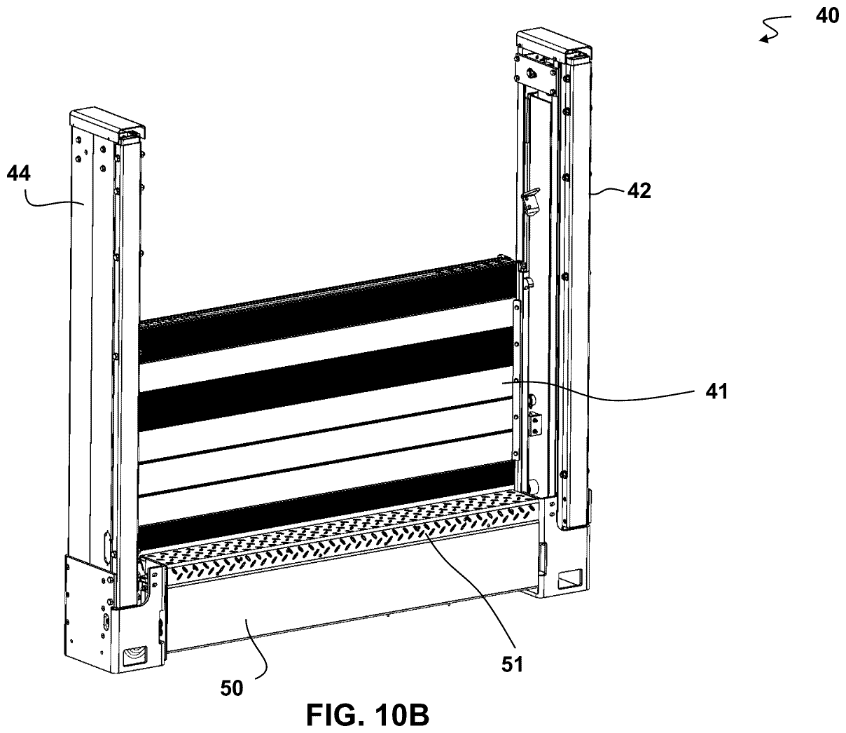

FIGS. 10A to 14 depict liftgate systems that may include a housing placed between left and right columns to house and encompass one or more parts and/or configurations required to mechanically raise and/or lower the lift platform (e.g., valves, switches, solenoids, batteries, and associated hydraulics, etc.), according to some embodiments.

FIG. 10A depicts a front perspective view of a liftgate system with an all encompassing housing in a stowed position, according to one embodiment. The liftgate system 40 may include a left column 42, a right column 44, a lift platform 41, and an all encompassing housing 50. The left column 42 and right column 44 may have one or more vertically-disposed hydraulic actuators (e.g., hydraulic cylinders) for vertically raising and lowering the lift platform 41. The batteries, motors, valves, switches, and solenoids to operate these hydraulic actuators may be disposed within the all encompassing housing 50. Controls to operate the liftgate may be disposed on a side of the left column 42 and/or the right column 44. Other locations for liftgate controls are possible and contemplated.

FIG. 10B depicts a rear perspective view of the liftgate system of FIG. 10A, according to one embodiment. The liftgate system 40 may include a left column 42, a right column 44, a lift platform 41, and an all encompassing housing 50. The all encompassing housing 50 may include an extension plate 51 on a top portion of the housing 50. The liftgate system 40 may be attached to a truck with a rear opening proximate the side of the liftgate system 40 shown in FIG. 10B.

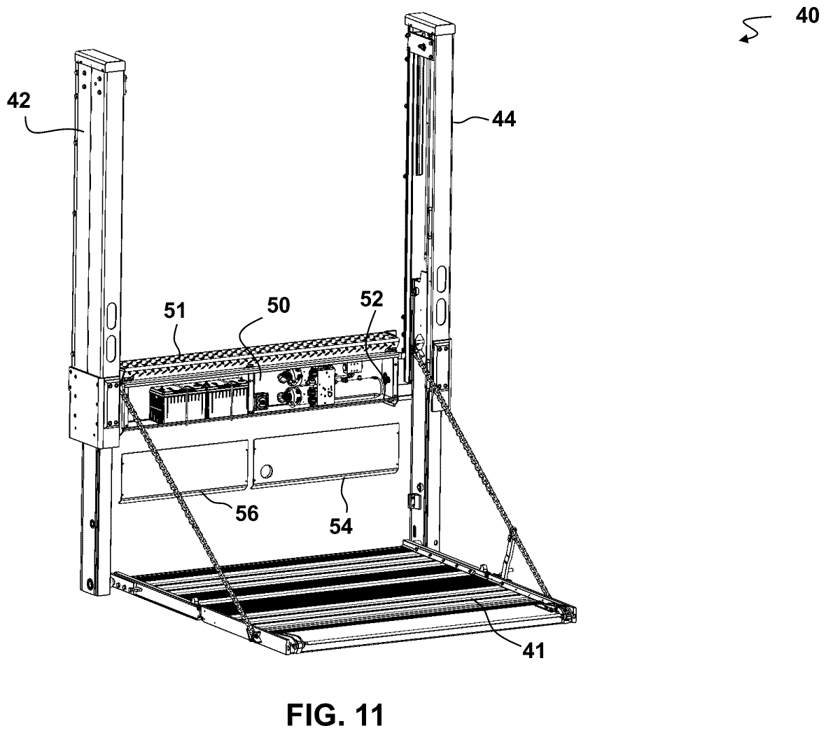

FIG. 11 depicts a front perspective view of the liftgate of FIGS. 10A and 10B in a lowered position with covers 54, 56 removed from the all encompassing housing 50, according to one embodiment. The liftgate system 40 may include a left column 42, a right column 44, a lift platform 41, and an all encompassing housing 50. The housing 50 may include the extension plate 51 on a top portion of the housing. A bottom portion of the housing 50 may be a cross bar 52. The housing 50 may include one or more covers 54, 56. One of the covers 54, 56 (e.g., cover 54) may have a cutout to provide access to a switch disposed in the housing 50.

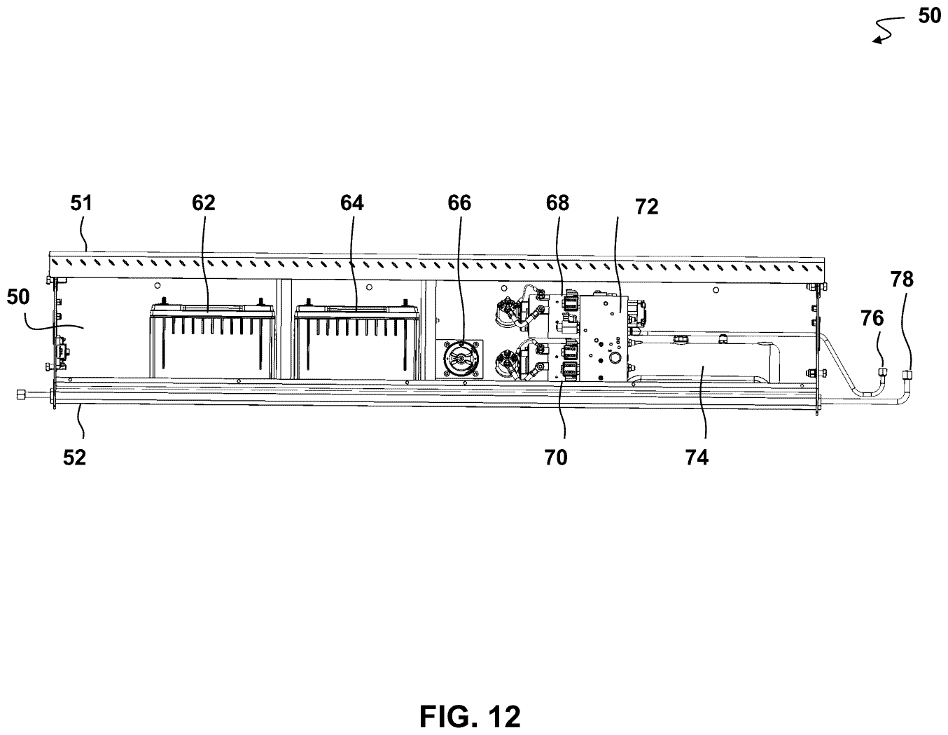

FIG. 12 depicts a front view of the all encompassing housing 50 with the covers removed, according to one embodiment. The housing 50 may include the extension plate 51 on a top portion of the housing 50. A bottom portion of the housing 50 may be a cross bar 52. A first, or left, portion of the housing 50 may include one or more batteries 62, 64. In many liftgate configurations, the batteries may be disposed in a separate battery enclosure that may be mounted to an underside of a vehicle. By placing the batteries 62, 64, and other components, into the housing 50, the liftgate installation process may be simplified. The liftgate system 50 may be attached to a truck, and the liftgate system 50 may be connected to the truck batteries for operation of lights, signals, and the like. The liftgate installation disclosed herein does not require the installation of a separate battery enclosure and the connection of the liftgate to the separate battery enclosure.

The housing 50 may also include a switch 66. The housing 50 may also include one or more actuation units 68, 70. The one or more batteries 62, 64 may provide power to the one or more actuation units 68, 70 as controlled by the switch 66. Each actuation unit 68, 70 may be a motor or pump configured to actuate up or down. The housing 50 may also include a motor block 72. The housing 50 may also include an oil reservoir 74. The oil reservoir 74 may be configured to provide hydraulic fluid to the one or more actuation units 68, 70. Hydraulic fluid may be pumped from the actuation units 68, 70 to one or more hydraulic actuators via one or more hydraulic pipes 76, 78.

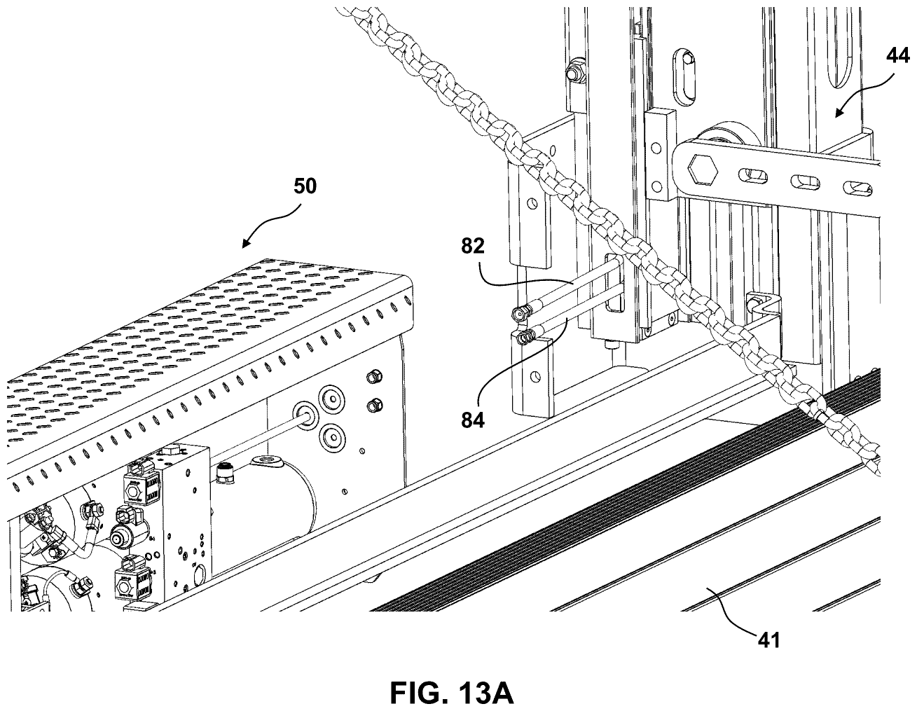

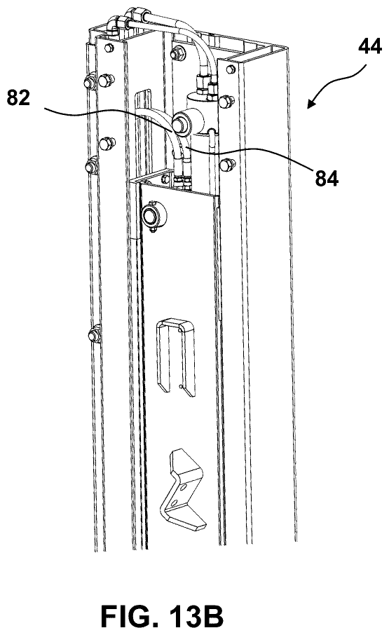

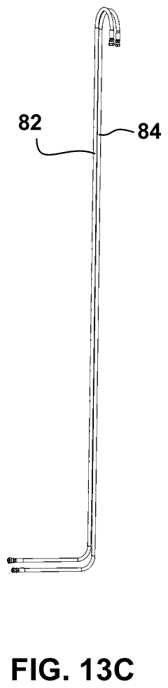

FIG. 13A depicts a perspective view of hydraulic hoses 82, 84 configured to connect to one or more pumps contained within the all encompassing housing 50 and entering a right support column 44, according to one embodiment. The hydraulic hoses 82, 84 may be routed through the support column 44 to provide any needed slack throughout all movements of the liftgate system. While the right support column 44 is shown in FIG. 13A, one or more hydraulic hoses 82, 84 may be disposed in the left support column (42, FIGS. 10A to 11). In some embodiments, one or more hydraulic hoses 82, 84 may be disposed in at least one of columns 12L, 12R each formed by an assembled parallel pair of extrusions as shown in FIGS. 1A to 9C.

FIG. 13B depicts a perspective view of the hydraulic hoses 82, 84 of FIG. 13A connecting to one or more actuators disposed within the right support column 44 for lowering and/or raising the lift platform (41, FIG. 13A), according to one embodiment.

FIG. 13C depicts a perspective view of the shape of the hydraulic hoses 82, 84 of FIGS. 13A and 13B disposed within the right support column (44, FIGS. 13A and 13B), according to one embodiment. The overall shape of the hydraulic hoses 82, 84 may be an L-shape proximate the all encompassing housing (50, FIG. 13A) and a J-shape proximate a top portion of the support column (44, FIG. 13B).

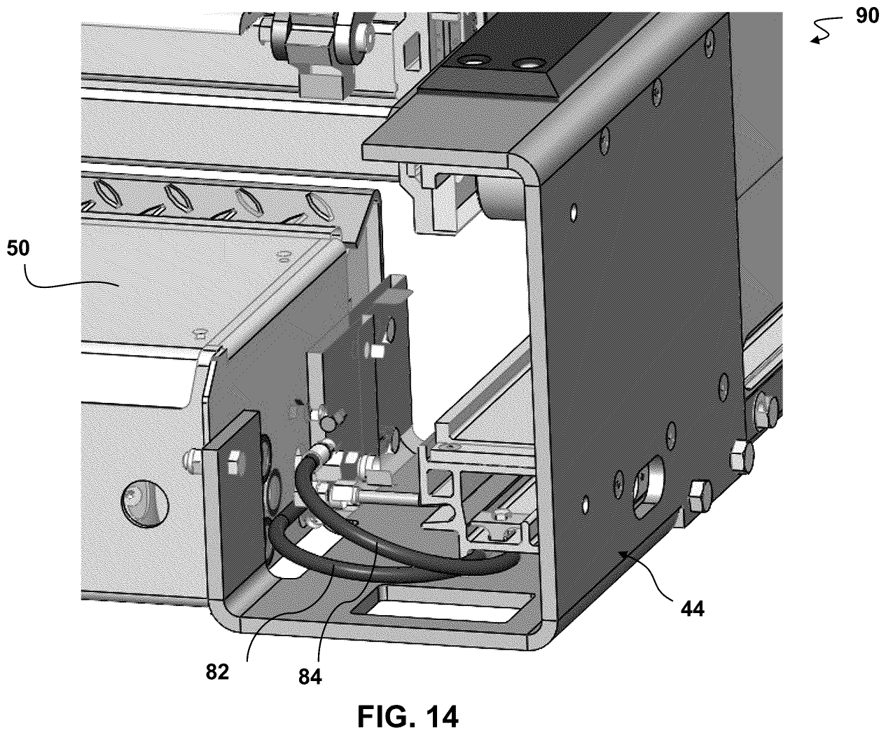

FIG. 14 depicts a bottom perspective view of a liftgate system 90 showing a connection of hydraulic hoses 82, 84 between a support column 44 and the all encompassing housing 50, according to one embodiment. The all encompassing housing 50 contains actuation units that may be connected to one or more hydraulic hoses 82, 84 disposed within one or more columns (e.g., column 44) to allow for movement of the lift platform system 90 without impinging the one or more hydraulic hoses 82, 84.

FIGS. 10 to 24E depict various lift platforms that may be included in liftgate systems, according to some embodiments. In some embodiments, the lift platform 11 of liftgate systems shown in FIGS. 1A to 9C may be any one of lift platforms shown in FIGS. 10 to 24E. Referring to FIGS. 10 to 24E, the lift platforms of the present embodiments may comprise one or more interchangeable inserts having the reduced weights, sufficient strengths, and a structure where the one or more interchangeable inserts may be replaced to one another based on the required capacity and weight according to the multiple purposes of the lift platforms of liftgate systems. The one or more interchangeable inserts may provide increased efficiency in weight support and fuel efficiency when the liftgate system is mounted on a vehicle.

In some embodiments, the liftgate system may include an extrusion lift platform. The insert of extrusion lift platform may contain multiple extruded platform segments, each of which has a thin rectangular slat structure and is connected to each other by engaging complementary connectors. Accordingly, the extrusion lift platform may provide superior strength while maintaining the light weight.

In some embodiments, the liftgate system may include a core lift platform. The insert of the core lift platform may include a top layer, a bottom layer, and a core layer disposed between the top layer and the bottom layer. The core layer may include a repeating series of cells, each of which has a three dimensional hollow structure defined by thin walls. With this structure, the core lift platform may significantly reduce the weight while providing sufficient strength. The repeating series of cells may have a fixed shape throughout the core layer. The fixed shape may be orientated substantially perpendicular to the top layer and the bottom layer such that at least one face of the cell is adjacent to the top layer and/or at least one face of the cell is adjacent to the bottom layer. A first adhesive component may be disposed between the top layer and the core layer. In some embodiments, the first adhesive component may be a weld applied to the perimeter of at least a portion of the top layer and/or the core layer. In other embodiments, the first adhesive component may be a layer of epoxy applied across at least a portion of the top layer and/or the core layer. The core layer may be adhered to the bottom layer by a second adhesive component. The second adhesive component may be disposed between the bottom layer and the core layer. The core layer may be adhered to the bottom layer by the second adhesive component. The cells of the core layer may comprise at least one of honeycomb-shaped cells, rectangular-shaped cells, square-shaped cells, and/or any polygonal-shaped cells. Each of the core layer, the top layer, and the bottom layer may be made of at least one of: metal, metal alloy, composite, fibers, fillers, foam such as Styrofoam™, polyethylene, polyurethane, and polystyrene, paper, Compolite®, Nomex®, Tedlar®, balsa (wood), plastic, polyester, nylon, and phenolic but is not limited thereto. The composite, fibers, fillers, and foam materials may be very light and solid. These materials may be cut and machined to form at least one of core layer, top layer, and bottom layer, and then the machined core layer, top layer, and bottom layer may be glued to each other. In another embodiment, the core layer may be welded to the top layer and to the bottom layer. Other forms of adherence of the core layer may be welded to the top layer and to the bottom layer are possible and contemplated.

In some embodiments, the liftgate system may include a grated lift platform, which has a structure in which a first set of parallel slats and a second set of parallel bars intersecting the first set are arranged.

In some embodiments, the liftgate system may include a lift platform with multiple extruded platform segments spaced apart from each other and a top layer attached on the top surfaces of the multiple spaced extruded platform segments. Each of spaced, extruded platform segments may have a thin C-shaped slat structure, and accordingly may significantly reduce the weight while providing sufficient strength. The detailed structures of the embodiments will be described below.

Specifically, with reference to FIG. 10, the disclosed liftgate system may include an extrusion lift platform 100. The liftgate system including the extrusion lift platform 100 may be configured for mounting at a mounting structure such as, but not limited to, a rear frame of a vehicle, such as a truck or trailer. For example, the liftgate system with the extrusion lift platform 100 may be attached to a rear opening of a vehicle bed of a vehicle, where the vehicle may include an extension plate. The load-carrying surfaces of the liftgate system may comprise said extrusion lift platform 100. The extrusion lift platform 100 may typically be square or rectangular in shape and include a rectangular platform section 110 and a rectangular foldable section 120, also known as a “flipover”. The platform section 110 may comprise or be covered with multiple extruded platform segments 111, which may be generally thin rectangular slats that lie along the length of the platform section 110. In some embodiments, each of the multiple extruded platform segments 111 may have a hollow tube shape.

Similarly, the foldable section 120 may also comprise or be covered with multiple extruded platform segments 121, which may be thin rectangular slats. The extruded platform segments 111 and 121 may be made of one or more extruded materials such as metal or metal alloy (e.g. extruded aluminum) but are not limited thereto. The extruded platform segments 111 and 121 may be made of any type of materials that may be manufactured by the extrusion process. The interiors of the extruded platform segments 111 and 121 may be supported with spaced internal wall structures. In some embodiments, the extruded platform segments 111 of the platform section and the extruded platform segments 121 of the foldable section 120 may be identical. The platform section 110 and foldable section 120 may be connected via a number of interlocking units 130 that may pivotally connect the sections 110, 120 in a manner that allows for folding of the folding section 120 underneath or onto the platform section 110. In certain embodiments, the interlocking units 130 may be male rods that couple with female holes present on both the platform section 110 and foldable section 120. The extrusion lift platform 100 may be used to lift payloads from one level, e.g., proximate the ground, up to another level, e.g., the vehicle bed of a vehicle, or vice versa. The liftgate system may be a stow away system and the foldable section 120 may be folded onto the platform section 110 during stowing of the extrusion lift platform 100. The extrusion lift platform 100 may be substantially aligned with the other parts of the liftgate system including, but not limited to, an extension plate. A ramp lip 140 may be positioned at one end of the foldable section 120 such that the ramp 140 may be attached to the end of the foldable section 120 distal from the platform section 110 when the foldable section 120 is unfolded. The ramp lip 140 may provide a ramping incline from a ground level to a top surface of the foldable section 120 and a top surface of the platform section 110.

FIG. 11A depicts a side view of a lift platform 200 of a liftgate system, in accordance with an embodiment of the invention. In some embodiments, the side view of the lift platform 100 shown in FIG. 10 may be similar to that of the lift platform 200. With reference to FIG. 11A, the lift platform 200 may include a platform section 210, and a foldable section 220 similar to the section described in the discussion of FIG. 10. The platform section 210 may comprise multiple extruded platform segments 211, and the foldable section 220 may also comprise multiple extruded platform segments 221. The platform section 210 and foldable section 220 may be connected via one or more interlocking units 230 that may be similar to interlocking units 130 in FIG. 10, which may pivotally connect the sections 210, 220 in a manner that allows for folding of the folding section 220 underneath or onto the platform section 210. In some embodiments, each of the plurality of extruded platform segments 211 of the platform section 210 and the plurality of extruded platform segments 221 of the flipover section 220 may have a hollow tube shape, and the interiors of the extruded platform segments 211, 221 may be supported with at least one spaced internal wall structure 212, 222. In this case, in some embodiments, the spaced internal wall structure 212, 222 may not be perpendicular to a top and bottom surfaces of the extruded platform segment 211, 221. For example, the internal of the extruded platform segment 211 may include two spaced internal wall structures 212, and each of these two spaced internal wall structures 212 may be formed to be inclined to a top and bottom surfaces of the extruded platform segment 211. In some embodiments, the two spaced internal wall structures 212 may be inclined in different directions, and the two spaced internal wall structures 212 may be closer to each other as they go from the top to the bottom, forming a V shape in a side view and cross section view. In other embodiments, the spaced internal wall structure 212, 222 may be perpendicular to a top and bottom surfaces of the extruded platform segment 211, 221

In some embodiments, at least a portion of a side of the lift platform 200 may be open and expose the internal supports of the platform section 210 and foldable section 220. Internal gaps 240 inside the extruded platform segments 211, 221 may be present that allow for lighter weight construction which results in increased fuel efficiency for vehicles that have the lift platform 200 attached. A ramp lip 250 may be positioned at one end of the foldable section 220 such that the ramp lip 250 may provide a ramping incline from a ground level to the top of the foldable section 220 and the platform section 210. In another embodiment, the lift platform 200 may be a single-piece platform, being comprised of either the platform section 210 or the foldable section 220. In another embodiment, the lift platform 200 may be a multi-piece platform with at least one section in addition to the platform section 210 and the foldable section 220. In some embodiments, at least a portion of the side of the lift platform 200 may be closed as shown in the lift platform 100 of FIG. 10.

FIG. 11B depicts a side view of a single extruded platform segment of an extrusion lift platform, in accordance with an embodiment of the invention. FIG. 11C depicts a side view of two extruded platform segments connected in parallel to form an extrusion lift platform, in accordance with an embodiment of the invention. With reference to FIGS. 11B and 11C, the present embodiments may include an extruded platform segment 1200, where multiple extruded platform segments 1200 may be connected in parallel to form an extrusion lift platform 1300. Each extruded platform segment 1200 may include a top portion 1202, a bottom portion 1204, and a middle portion 1206. The middle portion 1206 may be an internal wall structure that may support between the top and bottom portion 1202, 1204. The middle portion 1206 may be perpendicular to the top and bottom portion 1202, 1204 or form an inclined angle thereto. Each extruded platform segment 1200 may also include one or more connectors 1208, 1210, 1212, 1214 on both sides to connect or engage with one or more complementary connectors 1208, 1210, 1212, 1214 on another extruded platform segment 1200. In some embodiments, a top surface 1216 of the top portion 1202 may include a plurality of extruded grooves or other features to increase grip. Two or more extruded platform segments 1200 may be connected to the connection 132 in parallel to form an extrusion lift platform 1300. In some embodiments, the connection 132 may include welding adjacent extruded platform segments 1200 together. In some embodiments, the connection 132 may include adhering adjacent extruded platform segments 1200 together via an adhesive, nuts and bolts, or the like. The extruded platform segments 1200 may be identical or vary in appearance, shape, cell structure, cell shape, and the like. While a variety of lift platforms are described in the present disclosure, the specific configurations and structures of the lift platforms are largely dependent upon the requirements of specific applications. For example, it can be appreciated by those skilled in the art that the exact size, shape, material, and configuration of the core cells may be modified depending on the material or manufacturing costs and/or potential lift platform weight limits needed. The extruded platform segments (211, FIG. 11A) in the platform section (210, FIG. 11A) and/or the extruded platform segments (221, FIG. 11A) in the flipover section (220, FIG. 11A) may also be connected to each other by the methods described above.

FIG. 12 is a perspective view of a core lift platform of a liftgate system, in accordance with an embodiment of the invention. With reference to FIG. 12, the present embodiments may include a core lift platform 300. In many embodiments, the core lift platform 300 may be configured for mounting at a mounting structure such as, but not limited to, a rear frame of a vehicle, such as a truck or trailer. By way of example and not limitation, the core lift platform 300 may be attached to a rear opening of a vehicle bed of a vehicle, where the vehicle may include an extension plate. In various embodiments, the load-carrying surfaces of the core lift platform 300 may comprise at least one top layer 310, 320, at least one bottom layer (not pictured), and an interior core layer (not pictured) disposed between the at least one top layer 310, 320 and the at least one bottom layer. In some embodiments, the interior core layer may comprise a repeating series of cells of various shapes. In more embodiments, the top layers 310, 320 and/or bottom layers may be respectively affixed to the top and bottom surfaces of the core layer by a first adhesive component and/or a second adhesive component (See FIG. 14), each of which is disposed between the core layer and the top layer 310, 320 and between the core layer and the bottom layers, respectively. Each of the core layer, the top layer, and the bottom layer of the core lift platform 300 may be made of at least one of various materials, such as metal, metal alloy, composite, fibers, fillers, foam such as Styrofoam™, polyethylene, polyurethane, and polystyrene, paper, Compolite®, Nomex®, Tedlar®, balsa (wood), plastic, polyester, nylon, and phenolic but is not limited thereto.

In a number of embodiments, the core lift platform 300 may include a platform section 350 and a foldable section 360 (also known as a “flipover”). In further additional embodiments, the platform section 350 may comprise an internal core layer (not pictured) with a solid external top layer 310 and bottom layer with similar external covers on the sides of the platform section 350.

Similarly, the foldable section 360 may comprise an internal core layer (not pictured) with a solid external top layer 320 and bottom layer (not pictured) and similar external covers on the sides of the foldable section 360. In further embodiments, the platform section 350 and foldable section 360 may be connected via a number of interlocking units 330 that may pivotally connect the sections 350, 360 in a manner that allows for folding of the folding section 360 underneath or onto the platform section 350. In certain embodiments, the interlocking units 330 may be male rods that couple with female holes present on both the platform section 350 and foldable section 360. In still further embodiments, the core lift platform 300 may be used to lift payloads from one level, e.g., proximate the ground, up to another level, e.g., the vehicle bed of a vehicle, or vice versa. In additional embodiments, the liftgate system utilizing the core lift platform 300 may be a stow away system and the foldable section 360 may be folded onto the platform section 350 during stowing of the core lift platform 300. In still additional embodiments, the core lift platform 300 may be substantially aligned with the other parts of the liftgate system including, but not limited to, an extension plate. In certain embodiments, a ramp lip 340, comprising a single piece of supporting metal, or other material, may be positioned at one end of the foldable section 360 along its width such that the ramp 340 provides a ramping incline from the ground level to the top of the foldable section 360 and platform section 350. The ramp lip 340 may be disposed distal from the platform section 350 when the foldable section 360 is unfolded.

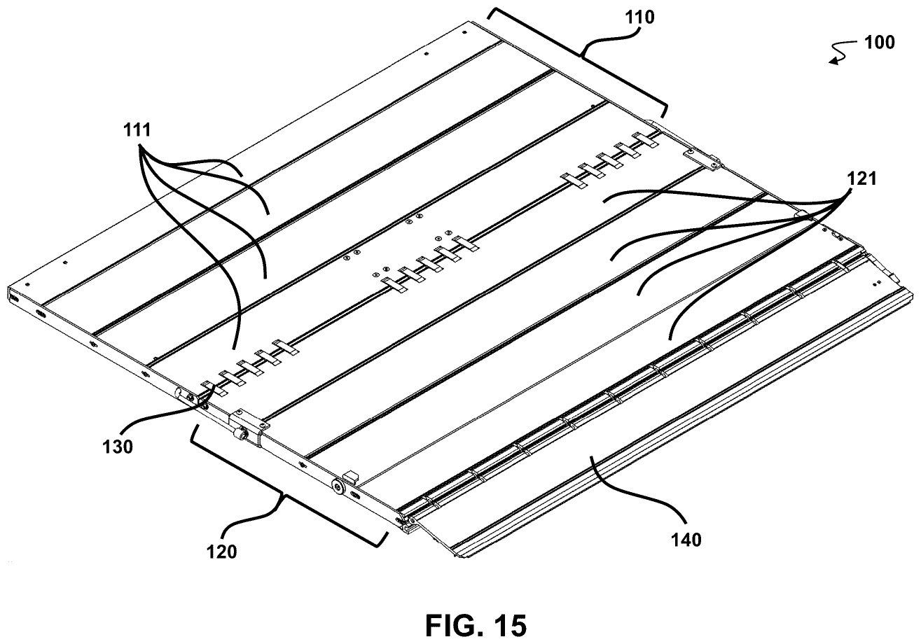

Each of the cells may be a three dimensional hollow structure defined by thin walls. With this structure, the core lift platform 300 may significantly reduce the weight while providing sufficient strength. The cells of the core layer may comprise at least one of honeycomb-shaped cells, rectangular-shaped cells, square-shaped cells, and/or any polygonal-shaped cells. In one embodiment, the cells of the core layer (not pictured) may be at least partially filled with a filler component (956, FIG. 15) such as foam or other similar materials to provide strength, noise dampening which may be caused by movement of the core cells (not pictured) within the core lift platform 300, and thermal insulation.

While a variety of core lift platforms are described above with reference to FIG. 12, the specific configurations and structures of the core lift platforms may be varied based upon the requirements of specific applications. For example, it can be appreciated by those skilled in the art that the sizes of the core lift platforms may be variable depending on the type and size of vehicle or structure that it may be utilized for. Additionally, the thickness and/or internal structure of the core lift platforms may be changed based upon the types of weights that will need to be lifted and/or the number of duty cycles that are expected of the core lift platform.

With reference to FIG. 13A, the present embodiments may include a single honeycomb-shaped core cell 700 structures. In additional embodiments, the cell height 730 (with respect to the Y-axis) of the honeycomb-shaped core cell 700 may be manufactured in various heights. In some embodiments, the cell height 730 may be between approximately 0.7 and 1.0 inches with a preferable height of approximately 0.8 to 0.9 inches but is not limited thereto. In some embodiments, the cell height 730 may be anywhere from approximately 0.5 to 4 inches. In certain embodiments, the cell height 730 of another style of honeycomb-shaped core cell 700 may be between approximately 1.2 inches and 1.6 inches, with a preferable height 730 of approximately 1.3 to 1.4 inches. In other embodiments, a height 730 of a third style of honeycomb-shaped core cell 700 may be between approximately 1.6 and 2.0 inches with a preferable height 730 of approximately 1.8 to 1.9 inches. Similarly, in more embodiments, the cell width or cell size 740 of a honeycomb-shaped core cell 700 may be between approximately 0.1 and 1 inches with a preferable cell size 740 of approximately 0.25 and 0.5 inches. In further additional embodiments, the cell wall thickness 750 may be between approximately 0.001 and 0.005 inches with preferable cell wall thickness of approximately 0.003 inches. In some embodiments, the cell size 740, or density, may be anywhere from ⅛-5.7 #, ⅛-4.5 #, ¼-5.2 #, 3/16-5.7 #, ⅜-2.3 #, ½-4.5 #, and/or ½-2.3 #, where X/X is cell size in inches and X·X # is honeycomb density in Pounds per Cubic Foot.

In further embodiments, the density of the honeycomb-shaped core cell 700 and core layer may be manufactured with a variety of densities. In some embodiments, the density of the honeycomb-shaped core cell 700 may be preferably between approximately 2.47 and 2.97 g/cm³ for aluminum alloys. In yet further embodiments, the structure of the honeycomb-shaped core cell 700 may be non-perforated.

In various embodiments, the honeycomb-shaped core cell 700 and resulting core layer (950, FIG. 15) may be made of at least one of various materials, such as metal, metal alloy, composite, fibers, fillers, foam such as Styrofoam™, polyethylene, polyurethane, and polystyrene, paper, Compolite®, Nomex®, Tedlar®, balsa (wood), plastic, polyester, nylon, and phenolic but is not limited thereto. FIG. 13B depicts various materials of a honeycomb-shaped core cell in a magnified view of an M portion in FIG. 13A, in accordance with embodiments of the invention. With reference to FIGS. 13A and 13B, in various embodiments, the honeycomb-shaped core cell 700 and resulting core layer may be manufactured with a metal or metal alloy 701. In certain embodiments, the honeycomb-shaped core cell 700 and resulting composite core layer may be manufactured out of an aluminum alloy, such as a 3003 alloy. Other possible alloys for the honeycomb-shaped core cell 700 and resulting composite core layer are possible and contemplated. In some embodiments, the core cell 700 may be a 3003, 5052, 5052N, and/or 5056 alloy. In some embodiments, the core cell 700 may comprise one or more aluminum alloys, such as the 3000, 5000, 6000, and/or 7000 series.

In some embodiments, the honeycomb-shaped core cell 700 may be made of any one or a combination of various composites or foams 702 to 709. The honeycomb-shaped core cell 700 may be made of foam 702, such as polyethylene, polyurethane, and polystyrene, but is limited thereto. The composite may be a combination of two or more constituent materials with different physical and chemical properties. The two or more constituent materials of the honeycomb-shaped core cell 700 may include matrix material and/or reinforcement material. The matrix material may be monolithic material in which the reinforcement material may be embedded and uniformly distributed throughout the matrix material. The reinforcement materials may be at least one of high-strength additives distributed inside the matrix material. For example, in some embodiments, the honeycomb-shaped core cell 700 may be made of composite 703 including foam as matrix material and fibers as reinforcement materials. In this case, the foam may be polyethylene, polyurethane, polystyrene, and the like, and the reinforcement material may be various type of fibers or fillers.

In some embodiments, the honeycomb-shaped core cell 700 may be made of composite with short fibers 703, 704, composites with long fibers 705, 706, composite with particles 707, composite with layers 709, composite with flakes 705, and others. In some embodiments, the plurality of short fibers, or chopped fibers, may be discontinuously distributed inside the matrix materials with no constant orientation. In another embodiments, the plurality of short fibers may be discontinuously distributed inside the matrix materials with the same orientation. In some embodiments, as shown in the composite 706, the plurality of long fibers may be woven. In some embodiments, as shown in the composite 705, the plurality of long fibers may be continuously arranged in parallel to each other inside the matrix materials. The combined material of the two or more constituent materials may have different characteristics from their original properties of each of the two or more constituent materials. The composite of the honeycomb-shaped core cell 700 may provide high strength to weight ratio. The composite may weigh approximately one fourth of steel and less than three fourth of aluminum but much stronger and stiffer than both materials per weight. Accordingly, the lift platform with the core layer made of these materials may significantly reduce the weight while providing sufficient strength.

In some embodiments, the shape of the core cell of the core layer may not be limited to a honeycomb shape. The core cell of the core layer may be any of rectangular-shaped cell, square-shaped cell, and/or any polygonal-shaped cell. In some embodiments, the core cell may be at least partially filled with a filler component such as foam or other similar materials to provide strength, noise dampening which may be caused by movement of the core cells, and thermal insulation.

With reference to FIG. 14, the present embodiments include a core layer 800 of a core lift platform, which comprises a plurality of honeycomb-shaped cells, in accordance with an embodiment of the invention. In many embodiments, the core layer 800 comprises a top layer 820, a bottom layer 810, and a cell layer 830 that may be a series of repeating core cells 700 arranged together on a layer. In a number of embodiments, the top and bottom of the cell layer 830 may be covered by flat metal sheets that make the bottom layer 810 and the top layer 820, respectively. In additional embodiments, the flat sheets may be made of aluminum. In some embodiments, the cell layer 830 may be made out of materials including, but not limited to, metal such as Aluminum, metal alloy, composite, fibers, fillers, foam, such as Styrofoam™, polyethylene, polyurethane, and polystyrene, paper, Compolite®, Nomex®, Tedlar®, balsa (wood), plastic, polyester, nylon, and/or phenolic. The materials of cell layer 830 may be made with or without reinforcement materials, such as fibers or fillers. In certain embodiments, the bottom layer 810 and top layer 820 may be between 1/32 and ¼ inch in thickness.

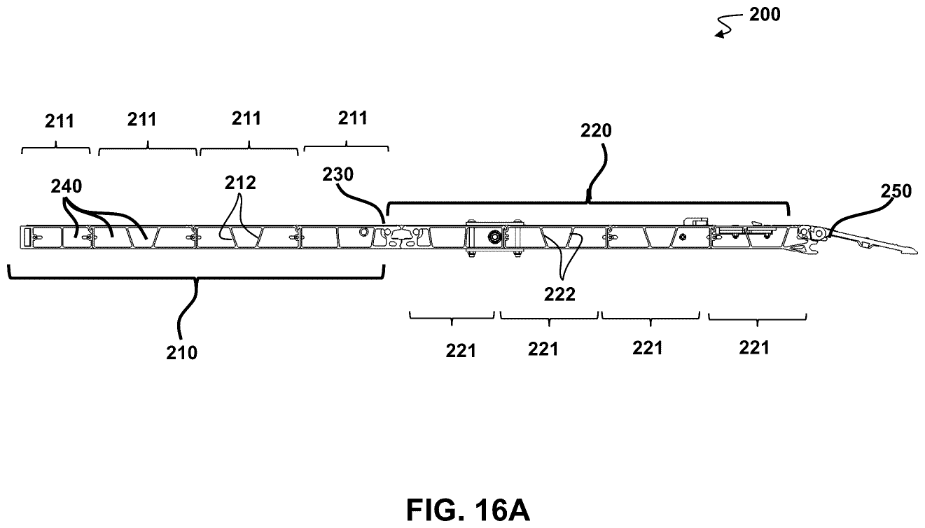

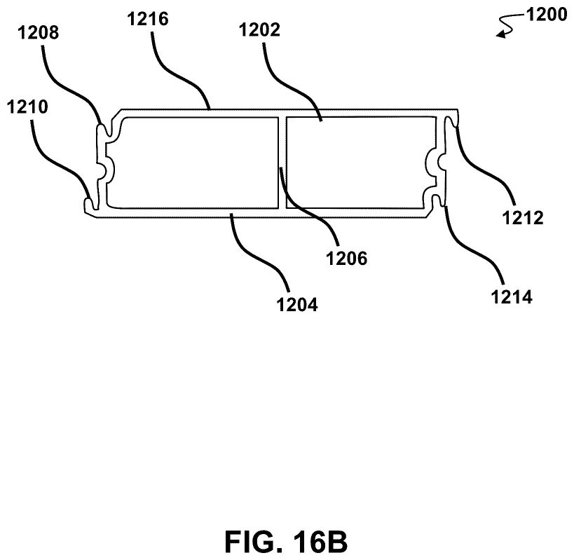

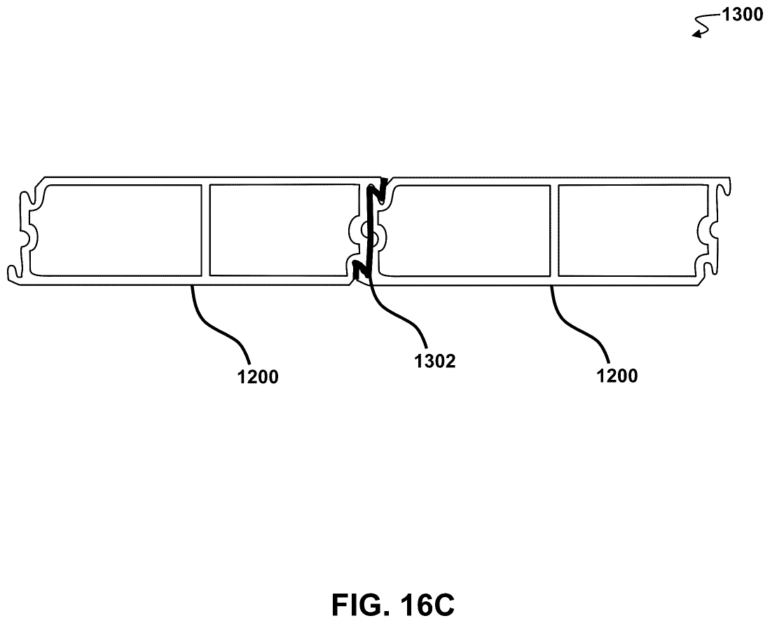

In the embodiment shown in FIG. 14, the cell layer 830 comprises a series of honeycomb structures similar to the honeycomb structures described in the discussion of FIG. 13A. Those skilled in the art will recognize that the cell layer 830 may comprise any number of cell shapes and sizes, including, but not limited to, a rectangular, triangular, and/or square shape as shown in the discussion of FIG. 16. In more embodiments, the top layer 820 and the bottom layer 810 may be adhered to the cell layer 830 by a layer of adhesive applied between each layer and the cell layer 830. The cell layer 830 may be affixed to the top layer 820 by a first adhesive component 870. The cell layer 830 may be affixed to the bottom layer 810 by a second adhesive component 860. In additional embodiments, the entire core layer height 840 may be calculated as the sum of the thickness of the bottom layer 810, core layer 830, top layer 820, and any adhesive components 860, 870. In still additional embodiments, the height of the cell layer 850 may be determined as the distance between the inner surfaces of the bottom layer 810 and top layer 820. The fixed shape of each cell 700 in the core layer 800 may be orientated substantially perpendicular to the top layer 820 and the bottom layer 810 such that at least one face 825 of the cell is adjacent to the top layer and bottom layer.

FIG. 15 is a perspective cutaway view of a core lift platform with a core layer having a plurality of honeycomb-shaped cells, in accordance with an embodiment of the invention. With reference to FIG. 15, the present embodiments include the core lift platform 900, where the core lift platform 900 comprises multiple internally arranged honeycomb-shaped core cells 700. In many embodiments of the invention, the core lift platform 900 may be configured for attaching to a liftgate system, which thereby may be configured for mounting at a mounting structure such as, but not limited to, a rear frame of a vehicle (e.g., a truck or trailer). By way of example and not limitation, the core lift platform 900 may be installed on a liftgate system attached to a rear opening of a vehicle bed of a vehicle, where the vehicle may include an extension plate. In a number of embodiments, the core lift platform 900 comprises a platform section 910 and a foldable section 920 (also known as a “flipover”). In further embodiments, the platform section 910 and foldable section 920 may be connected via a number of interlocking units 930 that may pivotally connect the sections in a manner that allows for folding of the folding section 920 underneath or onto the platform section 910. In still further embodiments, the core lift platform 900 may be used to lift payloads from one level, e.g., proximate the ground, up to another level, e.g., the vehicle bed of a vehicle, or vice versa.

In additional embodiments, the liftgate system utilizing the core lift platform 900 may be a stow away system and the foldable section 920 may be folded onto the platform section 910 during stowing of the core lift platform 900. In still additional embodiments, the core lift platform 900 may be substantially aligned with the other parts of the liftgate system including, but not limited to, an extension plate. In certain embodiments, a ramp lip 940 may be positioned at one end of the foldable section 920 such that the ramp lip 940 provides a ramping incline from the ground level to the top of the foldable section 920 and platform section 910. In still yet additional embodiments, the internal honeycomb-shaped cells of a core layer 950 of the foldable section 920 is visible within the foldable section 920 allowing for visualization of how the honeycomb-shaped core cells 700 may be arranged and spaced in order to provide internal structural support for the core lift platform 900.

Similarly, the internal honeycomb-shaped cells of a core layer 955 of the platform section 910 is visible within the platform section 910. Those skilled in the art can appreciate that although the current cutaway views show the honeycomb-shaped cells of the core layers 950, 955 within the platform section 910 and foldable section 920, similar structures may also be placed in a similar fashion throughout the core lift platform 900. In still yet further embodiments, the honeycomb-shaped cells of the core layers 950, 955 may provide increased efficiency in weight support on the core lift platform 900 while also being lighter than other internal structures, thus decreasing overall liftgate system weight and increasing fuel efficiency if the liftgate system is mounted on a vehicle.

In a variety of embodiments, the size of the platform may be manufactured to meet specific applications. For example, the thickness, length, and/or width of a panel, including the platform section 910 and/or the foldable section 920, may be selected depending on the size of vehicle. By way of example and not limitation, a total panel thickness including the platform section 910 and/or the foldable section 920 may be anywhere from approximately 0.5 to 3 inches, plus a top and a bottom layer thickness but is not limited thereto. In some embodiments, adhesive component may add some thickness as well.

In yet additional embodiments, the top layer and bottom layer may be manufactured to be between approximately 1/32 inch and ¼ inch thick, but preferably is approximately ⅛ inch. In some embodiments, the top and bottom layer thickness may differ. In still additional embodiments, the top and bottom layers may be made of an aluminum alloy including, but not limited to, 6061. In some embodiments, the top and bottom layer aluminum alloy may comprise Aluminum skins such as 2024-T3, 6061-T6 and/or 7075-T6. In some embodiments, the top and bottom layer may comprise unidirectional fiberglass reinforced epoxy facings/epoxy bonded. In some embodiments, the top and bottom layer may comprise aluminum grade-T3 or T6. Further, in still more embodiments, the type of aluminum alloy grade may vary depending on the application required but may preferably be T6 grade aluminum. In yet still more embodiments, a film adhesive utilized between the core layers 950, 955 and each of the top and bottom layer may be applied to adhere the top and bottom layers to the internal core cells 700 of the core layers 950, 955. In certain more embodiments, the adhesive may be a modified epoxy film adhesive. In more additional embodiments, the sides of the panels including the platform section 910 and/or the foldable section 920 may be covered with a solid aluminum bar to protect the interior of the panels, such as the core layers 950, 955, from dust, dirt, and/or the elements. Some embodiments of the top and/or bottom layer may include additional core/metal sheets (top & bottom) materials: metal, metal alloy, composite, fibers, fillers, foam such as Styrofoam™, polyethylene, polyurethane, and polystyrene, paper, Compolite®, Nomex®, Tedlar®, balsa (wood), plastic, polyester, nylon, and phenolic but is not limited thereto.

With reference to FIG. 16, the present embodiments include a core lift platform 1000, where the core lift platform 1000 comprises multiple internally arranged rectangular-shaped core cells in core layers 1050, 1055. In many embodiments of the invention, the core lift platform 1000 may be configured for attaching to a liftgate system, which thereby may be configured for mounting at a mounting structure such as, but not limited to, a rear frame of a vehicle, such as a truck or trailer. By way of example and not limitation, the core lift platform 1000 may be installed on a liftgate system attached to a rear opening of a vehicle bed of a vehicle, where the vehicle may include an extension plate. In a number of embodiments, the core lift platform 1000 comprises a platform section 1010 and a foldable section 1020 (also known as a “flipover”) similar to the platform and foldable sections 310, 320 of FIG. 12. In further embodiments, the platform section 1010 and foldable section 1020 may be connected via a number of interlocking units 1030 that may pivotally connect the sections in a manner that allows for folding of the folding section 1020 underneath or onto the platform section 1010 in a similar manner to the interlocking units 330 described in FIG. 12. In still further embodiments, the core lift platform 1000 may be used to lift payloads from one level, e.g., proximate the ground, up to another level, e.g., the vehicle bed of a vehicle, or vice versa.

In additional embodiments, the liftgate system utilizing the core lift platform 1000 may be a stow away system and the foldable section 1020 may be folded onto the platform section 1010 during stowing of the core lift platform 1000. In still additional embodiments, the core lift platform 1000 may be substantially aligned with the other parts of the liftgate system including, but not limited to, an extension plate. In certain embodiments, a ramp lip 1040 may be positioned at one end of the foldable section 1020 such that the ramp lip 1040 provides a ramping incline from the ground level to the top of the foldable section 1020 and platform section 1010 similar to the ramp lip 340 in FIG. 12. In still yet additional embodiments, the internal rectangular-shaped core cells in the core layer 1050 of the foldable section 1020 is visible within the foldable section 1020 allowing for visualization of how the rectangular-shaped core cells may be arranged and spaced in order to provide internal structural support for the core lift platform 1000.

Similarly, the internal rectangular-shaped core cells 1055 of the platform section 1010 is visible within the platform section 1010. Those skilled in the art can appreciate that although the current cutaway views show the rectangular-shaped core cells in the core layers 1050, 1055 within the platform section 1010 and foldable section 1020, similar structures may also be placed in a similar fashion throughout the core lift platform 1000. In still yet further embodiments, the rectangular-shaped core cell in the core layers 1050, 1055 may provide increased efficiency in weight support on the core lift platform 1000 while also being lighter than other internal structures, thus decreasing overall liftgate system weight and increasing fuel efficiency if the liftgate system is mounted on a vehicle.

In a variety of embodiments, the size of the platform may be manufactured to meet specific applications. By way of example and not limitation, a total panel thickness may be anywhere from approximately 0.5 to 3 inches, plus a top and a bottom layer thickness. Adhesive component may add some thickness as well. In certain embodiments, a panel including the platform section 1010 and/or the foldable section 1020 may be between approximately 1.50 and 2.00 inches thick, but preferably approximately 1.75 inches thick. In certain other embodiments, a panel including the platform section 1010 and/or the foldable section 1020 may be manufactured to be between approximately 1.8 and 2.2 inches thick, but preferably approximately 2 inches thick. In yet additional embodiments, the top layer and bottom layer may be manufactured to be between approximately 1/32 inch and ¼ inch thick, but preferably is approximately ⅛ inch. In still additional embodiments, the top and bottom layers may be made of an aluminum alloy including, but not limited to, 6061. Further, in still more embodiments, the type of aluminum alloy grade may vary depending on the application required but may preferably be T6 grade aluminum. In yet still more embodiments, a film adhesive utilized between the core layers 1050, 1055 and each of the top and bottom layers may be applied to adhere the top and bottom layers to the internal core layers 1050, 1055. In certain more embodiments, the adhesive may be a modified epoxy film adhesive. In more additional embodiments, the sides of the panels including the platform section 1010 and/or the foldable section 1020 may be covered by one or more covers 1065. The one or more covers 1065 may be made from a solid aluminum bar to protect the interior of the panels, such as core layers 1050, 1055, from dust, dirt, and/or the elements.

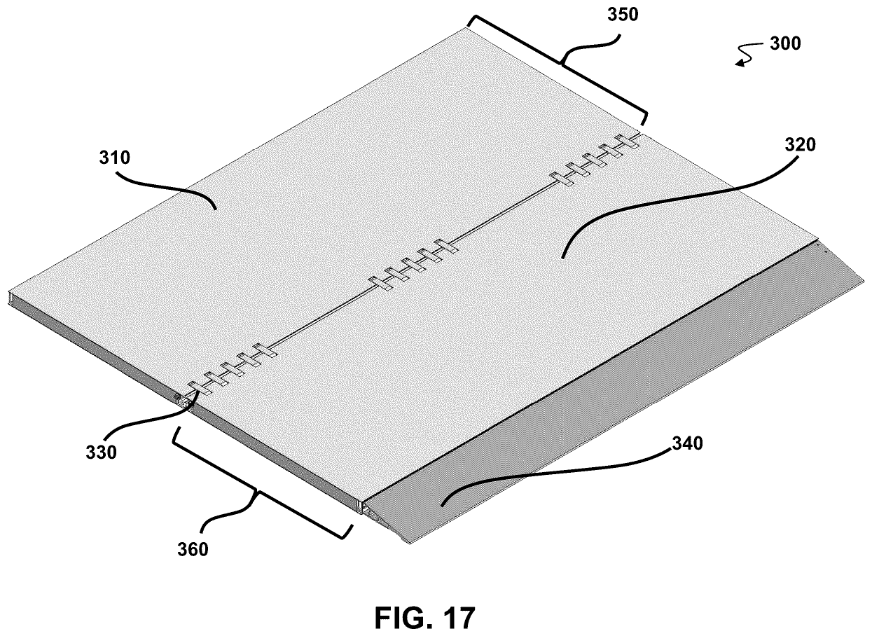

With reference to FIGS. 17A-17C, the present embodiments may include a grated flipover section on a lift platform 1100. The lift platform 1100 may include one or more substantially parallel slats 1102 and one more substantially parallel bars 1104. The one or more substantially parallel bars 1104 may be substantially perpendicular to the one or more substantially parallel slats 1102. The structure formed by the one or more substantially parallel slats 1102 and the one or more substantially parallel bars 1104 intersecting the one or more substantially parallel slats 1102 may form a grated core layer 1106. The one or more substantially parallel bars 1104 may be attached on top of and/or in an indentation in the one or more substantially parallel slats 1102. The lift platform 1100 of the present embodiments may further include a core platform section with an interior core layer. The grated flipover section may be connected to the core platform section that may be attached to a truck or trailer. In a variety of embodiments, the grated core layer 1106 of a lift platform 1100 in a liftgate system may be placed within the frame of another type of lift platform. By way of example and not limitation, the embodiment depicted in FIG. 17A comprises the grated core layer 1106 encompassed by a left plate 1108, a right plate 1110, upper extrusions 1112, and lower extrusions 1114. In certain embodiments, the upper extrusions 1112 and/or the lower extrusions 1114 may be comprised of an aluminum alloy. Those skilled in the art will recognize that the frame that encompasses the grated core layer 1106 may be made out of any suitable material that allows the liftgate system to operate more efficiently. In additional embodiments, the grated core layer 1106 may be covered by solid plating on the top and/or bottom of the grated core layer 1106. Internal gaps inside the grated flipover section may be present that allow for lighter weight construction which results in increased fuel efficiency for vehicles that have the lift platform 1100 attached. In some embodiments, the grated structure formed by the one or more substantially parallel slats 1102 and the one or more substantially parallel bars 1104 intersecting the one or more substantially parallel slats 1102 in the flipover section of the lift platform 1100 may be applied for a platform section of a lift platform.

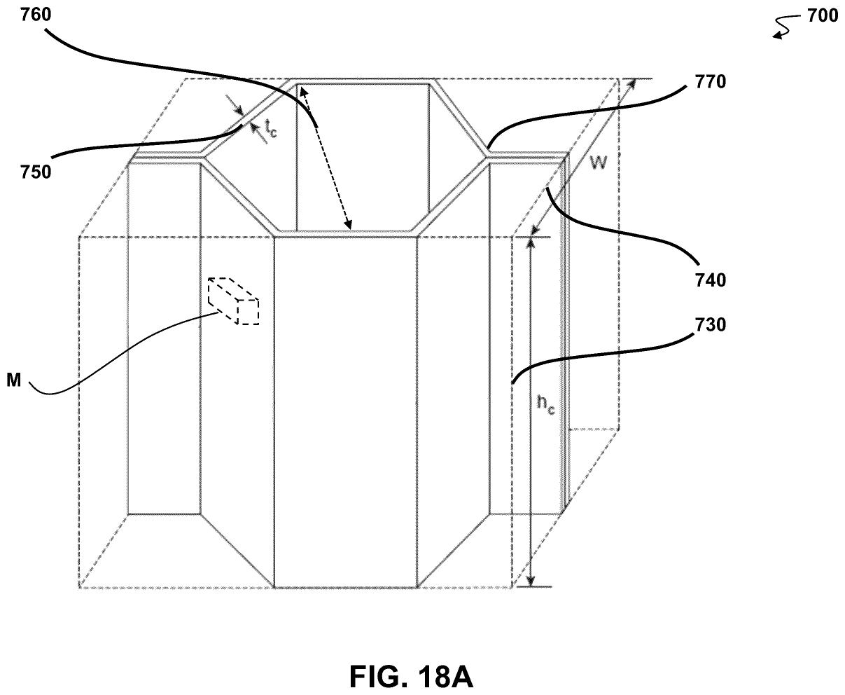

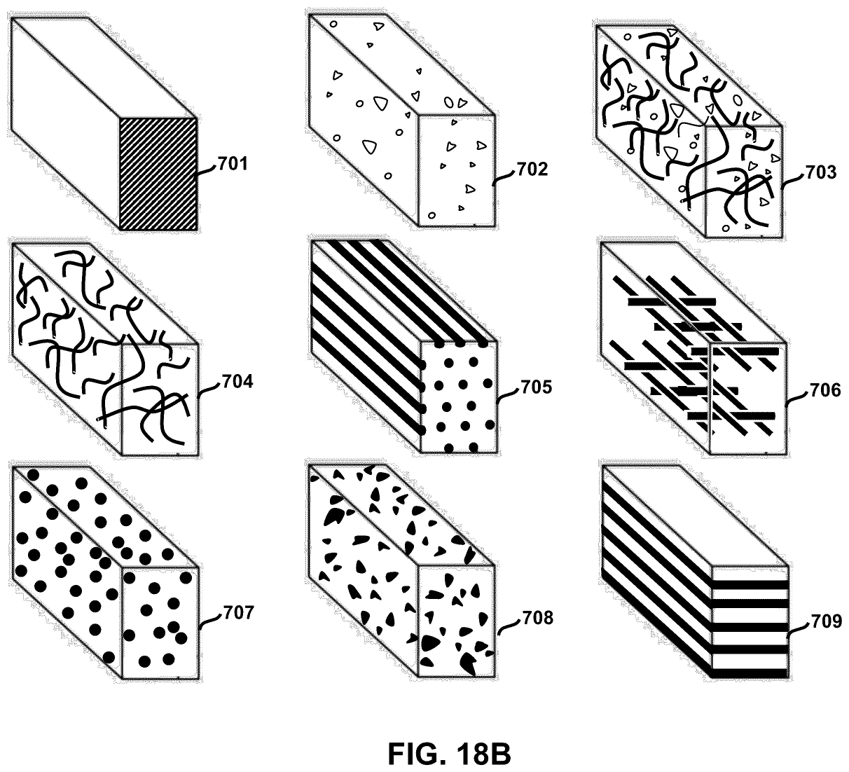

FIG. 18A is an exploded top perspective view of a flipover section with a multi-section core layer on a lift platform, in accordance with an embodiment of the invention. FIG. 18B is a bottom perspective view of a flipover section with a multi-section core layer on a lift platform of FIG. 18A. With reference to FIGS. 18A and 18B, the present embodiments may include a flipover section with a multi-section core layer 1251 in a lift platform 1250. The multi-section core layer 1251 may include multiple core inserts 1252 supported by one or more plates 1253, 1254. Specifically, the flipover section of the lift platform 1250 may include left and right plates 1254, an upper spacer 1256 connected to one ends of the left and right plates 1254, a lower spacer 1257 connected to the other ends of the left and right plates 1255, one or more middle support plates 1253 connecting between the upper spacer 1256 and the lower spacer 1257, and the multiple core inserts 1252. The multiple core inserts 1252 may be encompassed and supported by the upper spacer 1256, the lower spacer 1257, and at least two support plates of one or more middle support plates 1253 and end support plates 1254. Each of the core inserts 1252 may be made of at least one of various materials, such as metal, metal alloy, composite, fibers, fillers, foam such as Styrofoam™, polyethylene, polyurethane, and polystyrene, paper, Compolite®, Nomex®, Tedlar®, balsa (wood), plastic, polyester, nylon, and phenolic but is not limited thereto. Each of the core inserts 1252 may be any kind of combined materials and may further include fibers and/or fillers. In some embodiments, as shown in FIG. 18A, the flipover section of the lift platform 1250 may further comprise a top layer 1258 covering the multiple core inserts 1252 and the one or more supports 1253, 1254. The top surfaces of the multiple core inserts 1252 and the one or more supports 1253 may be glued and attached to the top layer 1258. In some embodiments, the multiple core inserts 1252 and the top layer 1258 may be glued into one piece, but if needed, multiple pieces.

In some embodiments, a lift platform of the present embodiments may include a flipover section with a multi-portion layer. The multi-portion layer in the flipover section may include multiple portions in a single layer in which the multiple portions are different from each other in at least one of structure and material.

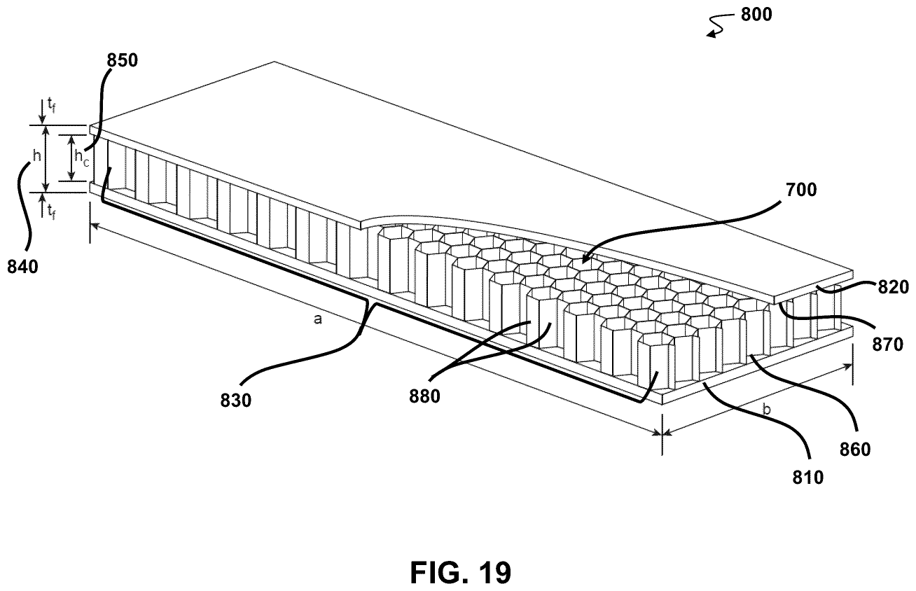

FIG. 19 is a top exploded perspective view of a platform section of a lift platform with spaced extruded platform segments, in accordance with an embodiment of the invention. With reference to FIG. 19, the present embodiments may include a platform section with multiple spaced extruded platform segments 1354 in a lift platform 1350. Specifically, the platform section of the lift platform 1350 may include a plurality of spaced extruded platform segments 1353, side tubes 1354 each connected to respective ends of the plurality of spaced extruded platform segments 1353, and a top layer 1358 covering the plurality of spaced extruded platform segments 1353 and the side tubes 1354. The multiple extruded platform segments 1353 may be spaced apart from each other and extended in width direction in parallel, and each of spaced extruded platform segments 1353 may have a C-shaped slat structure in a cross section. The top layer 1358 may be attached to top surfaces of the multiple spaced extruded platform segments 1353. The internal spaces formed inside the spaced extruded platform segments 1353 may reduce the weight while the extruded platform segments 1353 provide sufficient strength. The top layer 1358 may include a pattern such as a diamond plate across a top surface.

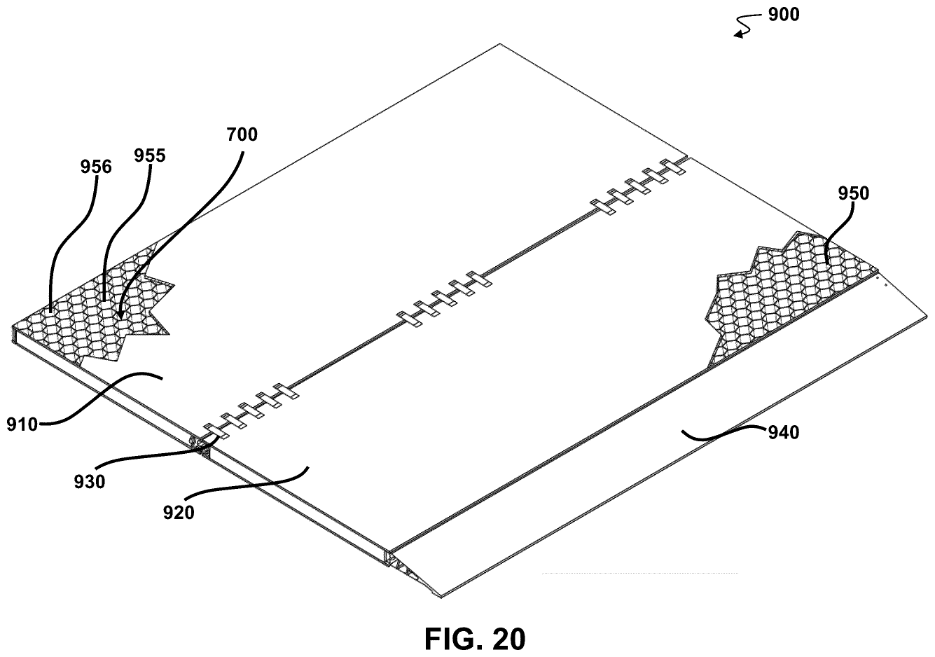

FIGS. 20A to 20E depict a lift platform 1400 of a liftgate system with alternate top insert options, in accordance with an embodiment of the invention. FIG. 20A depicts a top perspective view of a lift platform 1400 with alternate top insert options. The lift platform 1400 may include a platform assembly 1402 connected to a flipover assembly 1404. The platform assembly 1402 may receive one or more interchangeable inserts 1406, 1408, 1410, 1412, 1430. A first insert 1406 may include a core layer having a repeating structure of cells, such as honeycomb-shaped cells, rectangular-shaped cells, square-shaped cells, and/or polygonal-shaped cells. In some embodiments, the first insert 1406 may further comprise a top layer and a bottom layer on the top and bottom surfaces of the core layer as shown in FIG. 14, and the core layer may comprise a plurality of core cells shown in FIGS. 13A to 16. The first insert 1406 may include a pattern such as a diamond plate across a portion of a top surface but is not limited thereto. A second insert 1408 may include a pattern such as a diamond plate across a top surface. In some embodiments, the second insert 1408 may have spaced extruded platform segments with a top layer as shown in FIG. 19. A third insert 1410 may include a grated structure in which a first set of parallel slats and a second set of parallel bars intersecting the first set are arranged. In some embodiments, the third insert 1410 may have a similar grated structure shown in FIG. 17A to 17C. A fourth insert 1412 may include extruded platform segments, such as rectangular platform segments joined together. In some embodiments, the fourth insert 1412 may include a section of repeating cells. In some embodiments, the fourth insert 1412 may have a similar structure shown in FIGS. 10 to 11C. A fifth insert 1430 may include multiple portions 1431, 1432, 1433 that are different from each other in at least one of structures and/or materials. For example, a half of the fifth insert 1430 may be a first section 1431 made of metal plate, one quarter of the fifth insert 1430 may be a second section 1432 made of a grated structure, and the remaining portion of the fifth insert 1430 may be a third section 1433 made of composite. The one or more interchangeable inserts 1406, 1408, 1410, 1412, 1430 may be secured in an opening 1414 formed by the platform assembly 1402.

In some embodiments, the platform assembly 1402 may be connected to the flipover assembly 1404. In this case, the flipover assembly 1404 may also have a structure where one or more interchangeable inserts are received and fastened in an opening of the flipover assembly 1404. In this case, the one or more interchangeable inserts of the flipover assembly 1404 may include: a plurality of extruded platform segments (121, 221, FIGS. 10 and 11A) connected to each other, a core layer (950, 1050, FIGS. 15 and 16) having a repeating series of cells, a grated core layer (1106, FIGS. 17A to 17C) in which a first set of parallel slats and a second set of parallel bars intersecting the fir5sst set are arranged, a multi-section core layer (1251, FIGS. 18A and 18B) including multiple sections and at least one support plate therebetween, and a layer including multiple portions that are different from each other in at least one of structure and material.

FIG. 20B depicts a bottom perspective view of the lift platform 1400 of FIG. 20A with alternate top insert options 1406, 1408, 1410, 1412, 1430.

FIG. 20C depicts a top perspective view of the platform assembly 1402 for receiving an interchangeable insert of the lift platform 1400 of FIG. 20A. The platform assembly 1402 may include one or more insert push brackets 1416 for receiving an interchangeable insert from the top. In some embodiments, the flipover assembly 1404 may also include one or more insert push brackets 1417 for receiving an interchangeable insert. The one or more interchangeable inserts shown in FIGS. 20A-20B may be secured in the opening 1414 formed by the platform assembly 1402. The one or more insert push brackets 1416 may be placed over a top portion of the one or more interchangeable inserts and secured via one or more engagement mechanisms 1418 inserted through a portion of the one or more insert push brackets 1416.

One or more engagement mechanisms may be fasteners 1418 in one embodiment. In other embodiments, said engagement mechanisms may include mechanical fasteners such as Bolts and screws, threaded fasteners used to join materials together, typically with nuts or by threading into materials. Examples may include hex bolts, carriage bolts, machine screws, wood screws, sheet metal screws.

In other embodiments, said engagement mechanisms may include nuts, such as threaded fasteners that mate with bolts or screws to secure materials. Examples include hex nuts, wing nuts, lock nuts, cap nuts.

In other embodiments, said engagement mechanisms may include washers, such as used with bolts and screws to distribute load and prevent damage. Examples include flat washers, lock washers, fender washers.

In other embodiments, said engagement mechanisms may include rivets, such as permanent mechanical fasteners used to join materials by deforming the tail end after insertion. Examples include solid rivets, blind rivets, pop rivets.

In other embodiments, said engagement mechanisms may include pins, such as cylindrical fasteners used to locate or hold components together. Examples include dowel pins, split pins, cotter pins, and clevis pins.

In other embodiments, said engagement mechanisms may include anchors, such as used to secure fasteners in materials like concrete or drywall. Examples include expansion anchors, toggle bolts, plastic anchors.

In other embodiments, said engagement mechanisms may include adhesive fasteners, such as tape and pressure-sensitive adhesive on one or both sides, used to bond materials. Examples include duct tape, masking tape, double-sided tape.

In other embodiments, said engagement mechanisms may include glue, such as liquid adhesive that bonds materials upon curing. Examples include epoxy, super glue, wood glue, polyurethane glue.

In other embodiments, said engagement mechanisms may include magnetic fasteners, such as magnetic clips: use magnetic force to hold materials together. Examples include magnetic name badges, magnetic cabinet latches.

In other embodiments, said engagement mechanisms may include magnetic strips, such as flexible magnets used to secure lightweight objects. Examples include refrigerator magnets and magnetic tape.

In other embodiments, said engagement mechanisms may include interlocking fasteners, such as zippers: interlocking teeth fasteners used in clothing and bags. Examples include coil zippers, invisible zippers, metal zippers.

In other embodiments, said engagement mechanisms may include hook and loop fasteners, such as two-part fasteners consisting of hooks and loops. Examples include Velcro strips, hook-and-loop cable ties.

In other embodiments, said engagement mechanisms may include snap fasteners, such as interlocking discs used in clothing and accessories. Examples include press studs, snap buttons.

In other embodiments, said engagement mechanisms may include specialized fasteners, such as cable ties: used to bundle and secure cables and wires. Examples include nylon cable ties, reusable cable ties, metal cable ties.

In other embodiments, said engagement mechanisms may include clips and clamps, such as used to hold or secure objects in place. Examples include spring clips, hose clamps, binder clips.

In other embodiments, said engagement mechanisms may include buttons, such as used in clothing to fasten materials together. Examples include sew-on buttons, snap buttons, toggle buttons.

In other embodiments, said engagement mechanisms may include latches, such as mechanical fasteners that allow for secure closure and easy opening. Examples include toggle latches, cam latches, slam latches.

In other embodiments, said engagement mechanisms may include innovative fasteners, such as quick-release fasteners: designed for rapid attachment and detachment. Examples include quick-release pins, quick-release buckles.

In other embodiments, said engagement mechanisms may include reusable fasteners, such as designed for multiple uses without losing efficacy. Examples include reusable zip ties, reusable twist ties.

In other embodiments, said engagement mechanisms may include tamper-resistant fasteners, such as designed to prevent unauthorized removal. Examples include security screws, breakaway bolts.

FIG. 20D depicts a bottom perspective view of the platform assembly 1402 for receiving the insert connected to the flipover assembly of the lift platform 1400 of FIG. 20A. The one or more interchangeable inserts shown in FIGS. 20A-20B may be secured in the opening 1414 formed by the platform assembly 1402. The one or more interchangeable inserts may be secured to the platform assembly 1402 via one or more engagement mechanisms 1420 secured through one or more openings in a bottom portion of the platform assembly 1402. In one embodiment, the one or more engagement mechanisms 1420 may be screws that are secured through one or more openings or apertures in the platform assembly 1402 and one or more corresponding openings or apertures in the one or more interchangeable inserts. The one or more insert push brackets (1416, FIG. 20C) may be used to secure a top portion of the one or more interchangeable inserts to the platform assembly 1402 and the one or more engagement mechanisms 1420 may be used to secure a bottom portion of the one or more interchangeable inserts to the platform assembly 1402.

FIG. 20E depicts a top view of the platform assembly 1402 for receiving the insert connected to the flipover assembly 1404 of the lift platform 1400 of FIG. 20A.

FIG. 20F depicts a flowchart of a method for assembling and utilizing a lift platform of a liftgate system, in accordance with an embodiment of the invention. With reference to FIG. 20F, the method 1450 may begin with connecting between the flipover assembly and platform assembly via one or more connectors, such as hinge (step 1451). Based on the need for the capacity and fuel efficiency, at least one first interchangeable insert among one or more interchangeable inserts may be selected and respectively placed via at least one of an opening of the platform assembly and flipover assembly from the top (step 1452). Then, one or more insert push brackets may be placed over a top portion of the at least one first interchangeable insert (step 1453), and the first interchangeable insert may be secured to at least one of the platform assembly and flipover assembly via engagement mechanisms inserted through a portion of the insert push brackets (step 1454). With the lift platform equipped with the first interchangeable insert, first type freights may be loaded and/or unloaded to a vehicle to which the liftgate system including the lift platform is connected (step 1455). If needed, the first interchangeable insert may be interchanged with a second interchangeable insert different from the first interchangeable insert via the opening based on the load capacity and/or fuel efficiency (step 1456). Then, second type freights may be loaded and/or unloaded to the vehicle using the lift platform equipped with the second interchangeable insert (step 1457).

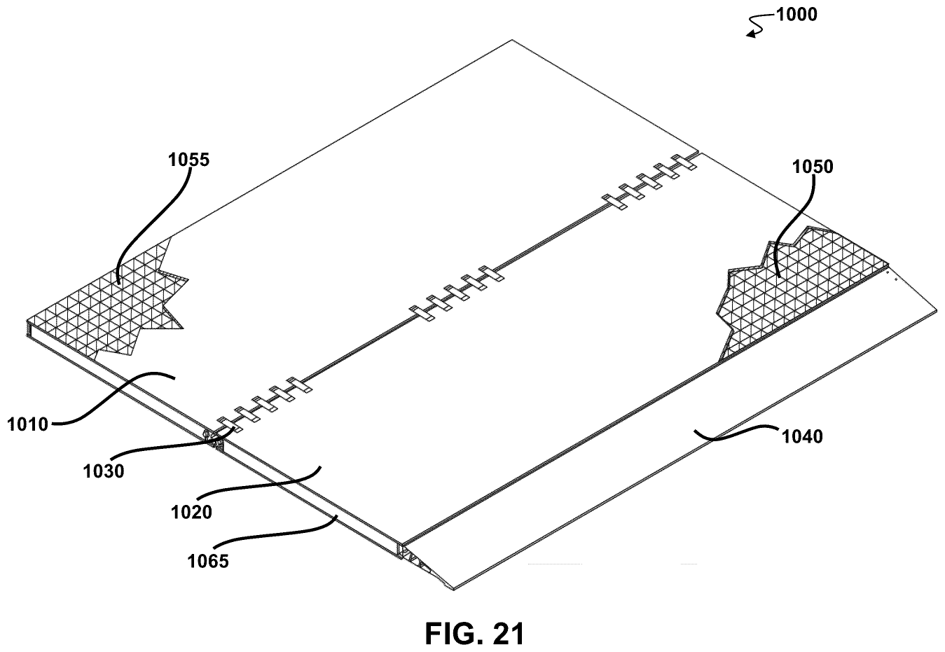

FIGS. 21A to 21D depict a lift platform 1500 of a liftgate system with alternate side insert options, in accordance with an embodiment of the invention. FIG. 21A depicts a top perspective view of a lift platform 1500 with alternate side insert options. The lift platform 1500 includes a platform assembly that may receive one or more interchangeable inserts 1502, 1504, 1506, 1508, 1530. A first insert 1502 may include a core layer having a repeating structure of cells, such as honeycomb-shaped cells, rectangular-shaped cells, square-shaped cells, and/or polygonal-shaped cells and include a pattern such as a diamond plate across a portion of a top surface. A second insert 1504 may include spaced extruded platform segments and a pattern such as a diamond plate across a top surface. A third insert 1506 may include a grated core layer in which a first set of parallel slats and a second set of parallel bars intersecting the first set are arranged. A fourth insert 1508 may include extruded platform segments, such as rectangular platform segments joined together. In some embodiments, the fourth insert 1508 may include a section of repeating cells. A fifth insert 1530 may include multiple portions 1531, 1532, 1533 that are different from each other in at least one of structures and/or materials. The one or more interchangeable inserts 1502, 1504, 1506, 1508, 1530 may be secured in an opening 1510 formed by the platform assembly. The platform assembly may include platform sides 1512, 1514, a hinge plate 1516 fixedly connected to one ends of the platform sides 1512, 1514, and a back plate 1518 attachably disconnected from the other ends of the platform sides 1512, 1514. The platform sides 1512, 1514 and the hinge plate 1516 may form an opening 1510 surrounded by a U shape of the platform sides 1512, 1514 and the hinge plate 1516. The one or more interchangeable inserts 1502, 1504, 1506, 1508, 1530 may be slid into this U-shaped opening 1510 in a plane substantially parallel to a plane formed by the platform sides 1512, 1514. One side of any one of the one or more interchangeable inserts 1502, 1504, 1506, 1508, 1530 may be connected to the back plate 1518, and the back plate 1518 may be used to secure the one or more interchangeable inserts 1502, 1504, 1506, 1508, 1530 to the platform sides 1512, 1514 once inserted into the U-shaped opening 1510.

FIG. 21B depicts a bottom perspective view of the lift platform 1500 of FIG. 21A with alternate inserts 1502, 1504, 1506, 1508, 1530.

FIG. 21C depicts a top view of a platform assembly for receiving an insert 1508 of the lift platform 1500 of FIG. 21A. The platform assembly includes platform sides 1512, 1514 connected to a hinge plate 1516 and a back plate 1518 that may be connected to the insert 1508 and/or platform sides 1512, 1514 of the platform assembly.

FIG. 21D depicts a bottom view of the platform assembly for receiving an interchangeable insert of the lift platform 1500 of FIG. 21A. The platform assembly includes platform sides 1512, 1514 connected to a hinge plate 1516 and a back plate 1518 that may be connected to the insert 1508 and/or platform sides 1512, 1514 of the platform assembly.

FIG. 21E depicts a flowchart of a method for assembling and utilizing a lift platform of a liftgate system, in accordance with an embodiment of the invention. With reference to FIG. 21E, the method 1550 may begin with disconnecting between the flipover assembly and platform assembly (step 1551). Then, based on the need for the capacity and fuel efficiency, at least one first interchangeable insert among one or more interchangeable inserts may be selected and slid in a plane parallel to the platform and/or flipover assembly into an opening surrounded by a U shape of platform sides and a hinge plate of at least one of the platform assembly and flipover assembly (step 1552). The exposed side portion of the first interchangeable insert surrounded by the U shape may be placed with a back plate (step 1553). Then, the back plate may be secured to the first interchangeable insert and/or platform sides of at least one of the platform and flipover assembly via engagement mechanisms (step 1554). With the lift platform equipped with the first interchangeable insert, first type freights may be loaded and/or unloaded to a vehicle to which the liftgate system including the lift platform is connected (step 1555). If needed, the first interchangeable insert may be interchanged with a second interchangeable insert, which is different from the first interchangeable insert, via the opening based on the load capacity and/or fuel efficiency (step 1556). Then, second type freights may be loaded and/or unloaded to the vehicle using the lift platform equipped with the second interchangeable insert (step 1557).

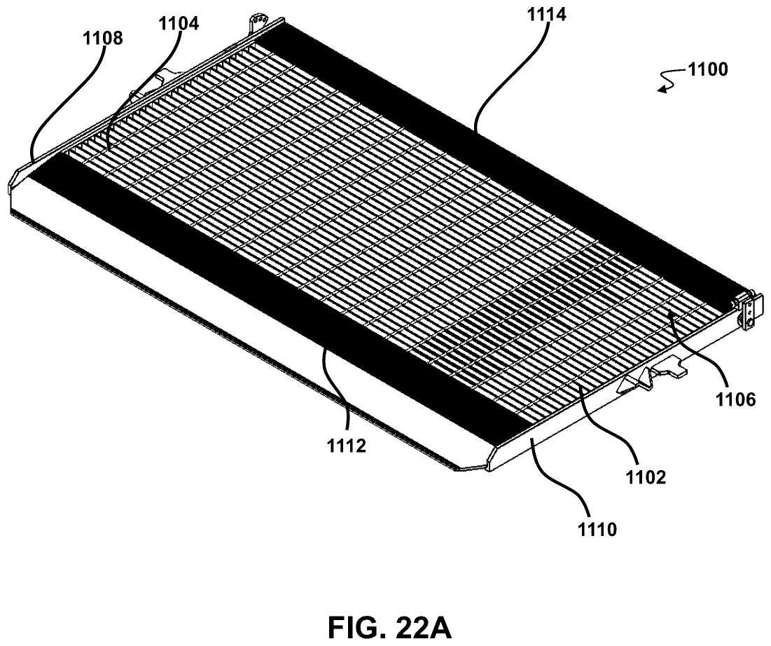

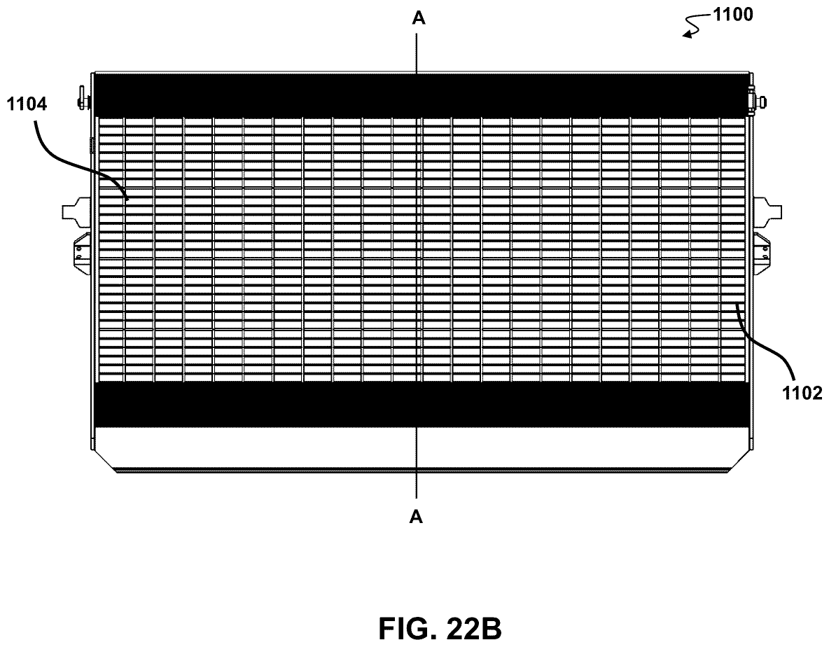

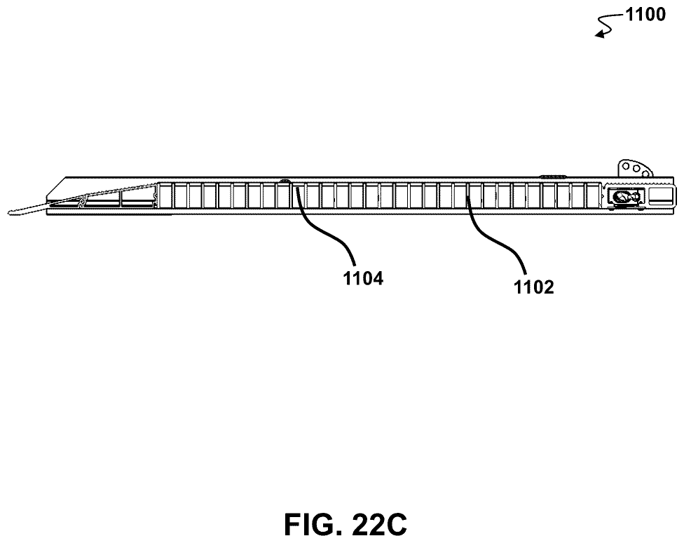

FIG. 22A depicts a top perspective view of a platform assembly 1600 for receiving an insert. The platform assembly 1600 includes platform sides 1612, 1614 connected to a hinge plate 1616 and a back plate 1618 that may be connected to an insert (not shown) and/or platform sides 1612, 1614 of the platform assembly 1600.

FIG. 22B depicts a top perspective view of the platform assembly 1600 for receiving an insert 1604 attached to the back plate 1618. In some embodiments, the back plate 1618 may be attached to the insert 1604 before being slid into the U-shaped opening 1606 of the platform assembly 1600.

FIG. 22C depicts a top perspective view of the platform assembly 1600 for receiving the insert into the platform sides and hinge plate. In other embodiments, the insert 1604 may be slid into the U-shaped opening of the platform assembly 1600 and then the back plate 1618 may be secured via the one or more engagement mechanisms 1602.

FIG. 22D depicts a top perspective view of the platform assembly 1600 with the insert 1604 inserted into the platform sides 1612, 1614 and hinge plate 1616 and secured with the back plate 1618.

FIG. 22E depicts a close-up top perspective view of the platform assembly 1600 showing engagement mechanisms 1602 for securing the back plate 1618 to the insert 1604 and the platform sides 1614. In some embodiments, the engagement mechanisms 1602 may be screws or bolts. Other engagement mechanisms are possible and contemplated.

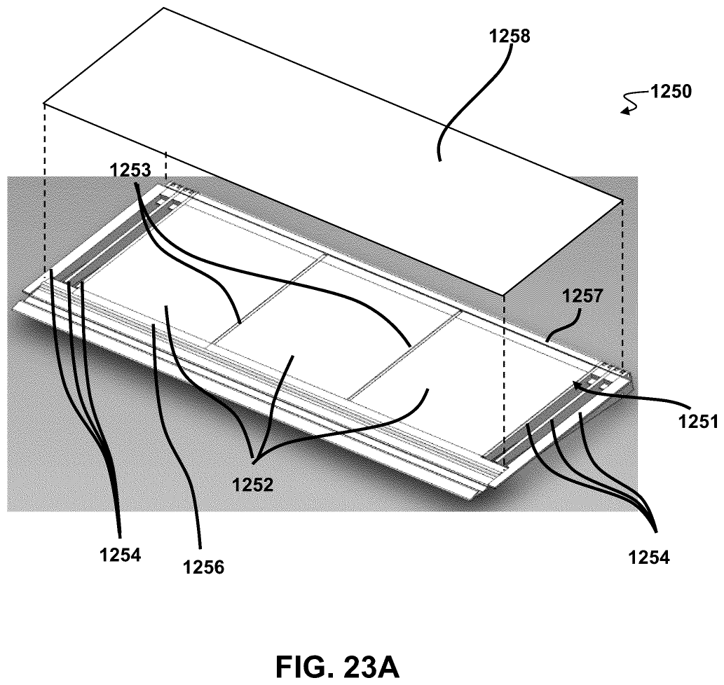

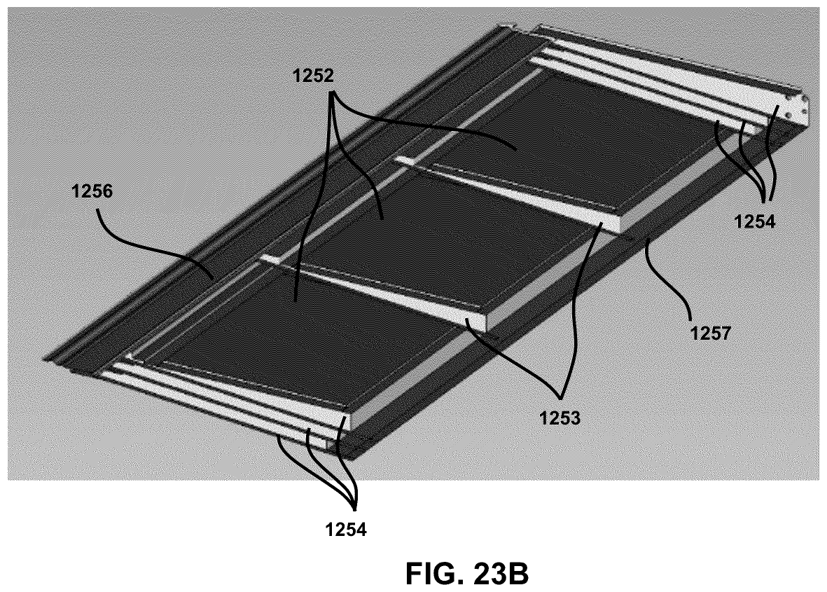

FIG. 23 depicts a close-up top perspective view of engagement mechanisms 1702 for securing the platform sides 1714 to the insert 1704 and back plate 1718 of a platform assembly 1700.

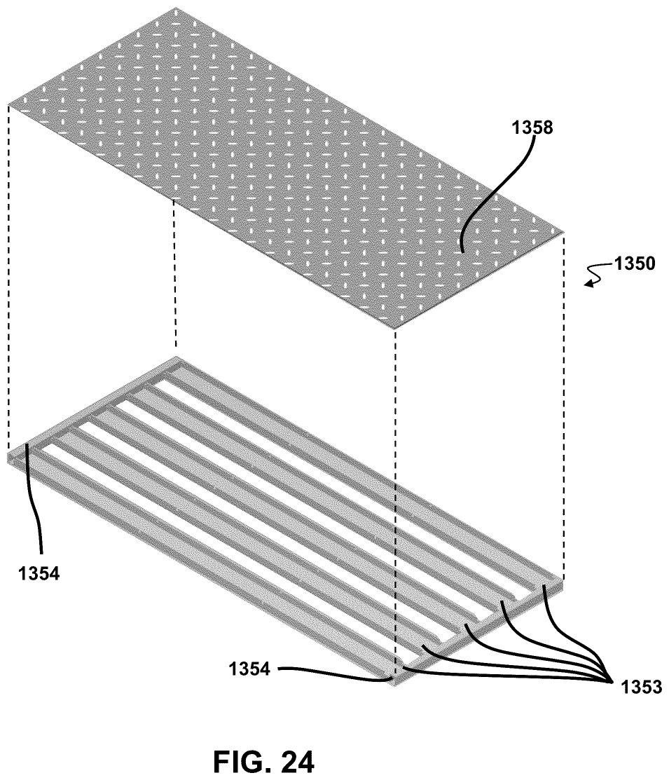

FIG. 24A depicts a top perspective view of a lift platform 1800 of a liftgate system having a platform section 1802 connected to a flipover section 1804 by a hinge. The platform section 1802 and flipover section 1804 may have at least one middle wall 1806 to further secure and/or support the insert 1808. In some embodiments, an opening of the platform section 1802 may be divided by the at least one middle wall 1806 into multiple sub-openings, and the multiple sub-openings may be received with the multiple sub-inserts 1808. Likewise, in some embodiments, an opening of the flipover section 1804 may be divided by the at least one middle wall into multiple sub-openings, and the multiple sub-openings may be received with the multiple sub-inserts.

FIG. 24B depicts a bottom perspective view of the lift platform 1800 of FIG. 24A having the platform section 1802 connected to the flipover section 1804 by a hinge.

FIG. 24C depicts a top view of the lift platform 1800 of FIG. 24A having the platform section 1802 connected to the flipover section 1804 by a hinge.

FIG. 24D depicts a bottom view of the lift platform 1800 of FIG. 24A having the platform section 1802 connected to the flipover section 1804 by a hinge.

FIG. 24E depicts a side view of the lift platform 1800 of FIG. 24A having the platform section 1802 connected to the flipover section 1804 by a hinge.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

What is claimed is:

1. A system comprising:
at least one column, each including:
an assembled parallel pair of a first extrusion and a second extrusion,
at least one bracket connecting the first extrusion and the second extrusion as one piece, and
at least one runner configured to slide along an internal space defined by the first extrusion and the second extrusion; and
a lift platform connected to the at least one runner.

2. The system of claim 1, wherein each of the first extrusion and the second extrusion includes an L-shape, and
wherein the assembled parallel pair of the first extrusion and the second extrusion includes a C-shape defining the internal space.

3. The system of claim 1, wherein the at least one bracket includes a top assembly bracket, and
wherein the top assembly bracket includes a four-sided polygon shape that fits the internal space and is configured to hold and connect the assembled parallel pair.

4. The system of claim 1, further comprising a mounting bracket connected to the back of the assembled parallel pair, and
wherein the mounting bracket is configured to mount the system to a vehicle.

5. The system of claim 4, wherein the at least one bracket includes a bottom assembly bracket that is configured to wrap around the outside of the assembled parallel pair and the mounting bracket and hold and connect the assembled parallel pair.

6. The system of claim 1, wherein the first extrusion includes a first extending portion and a second extending portion perpendicular to the first extending portion,
wherein the second extrusion includes a first extending portion and a second extending portion perpendicular to the first extending portion,
wherein the first extending portion of the first extrusion and the first extending portion of the second extrusion are arranged to extend in the same plane, and ends of the first extending portion of the first extrusion and the first extending portion of the second extrusion are engaged with each other via a pair of a groove and a tongue, and
wherein surfaces of the second extending portion of the first extrusion and the second extending portion of the second extrusion are arranged to face each other and extended in a parallel direction.

7. The system of claim 1, wherein the internal space defined by the first extrusion and the second extrusion is configured to contain one or more liftgate movement components.

8. The system of claim 7, wherein the one or more liftgate movement components contained in the internal space includes one or more hydraulic actuators, and
wherein the hydraulic actuators is configured to operate the at least one runner to lower and/or raise the lift platform connected to the at least one runner.

9. The system of claim 8, wherein the one or more liftgate movement components contained in the internal space includes one or more hydraulic hoses that is configured to provide hydraulic fluid to the one or more hydraulic actuators.

10. The system of claim 9, wherein the at least one column includes a left column and a right column;
wherein the system further comprises a housing disposed between the left column and the right column;
wherein the housing contains one or more actuation units; and
wherein the one or more hydraulic hoses are configured to connect between the one or more actuation units and the one or more hydraulic actuators.

11. The system of claim 10, wherein the hydraulic hoses includes an L-shape proximate the housing and a J-shape proximate a top portion of at least one of the left and right support columns that the one or more hydraulic hoses are disposed.

12. The system of claim 1, wherein the at least one of the first extrusion and the second extrusion further includes at least one cavity formed on the outer surfaces to receive one or more electrical lines and hydraulic lines.

13. The system of claim 1, wherein the lift platform comprises:
a platform assembly including an opening;
one or more interchangeable inserts configured to be received in the opening of the platform assembly; and
one or more engagement mechanisms configured to secure the one or more interchangeable inserts in the opening of the platform assembly.

14. A system comprising:
a left support column;
a right support column;
a lift platform connected between the left support column and the right support column;
a housing disposed between the left support column and the right support column; and
one or more hydraulic hoses disposed at least partially within one of the left and right support columns,
wherein the one or more hydraulic hoses are configured to connect to one or more actuation units disposed within the housing to provide hydraulic fluid to one or more hydraulic actuators disposed within the one of the support columns.

15. The system of claim 14, further comprising:
one or more batteries disposed within the housing, wherein the one or more batteries are configured to provide power to the one or more actuation units; and
an oil reservoir disposed within the housing, wherein the oil reservoir is configured to provide hydraulic fluid to the one or more actuation units.

16. The system of claim 14, wherein the one or more actuation units is configured to provide hydraulic fluid to the one or more hydraulic actuators to raise or lower the lift platform.

17. The system of claim 14, wherein the hydraulic hoses includes an L-shape proximate the housing and a J-shape proximate a top portion of at least one of the left support column and right support columns that the one or more hydraulic hoses are disposed.

18. The system of claim 14, wherein at least one of the left support column and the right support column includes an assembled parallel pair of a first extrusion and a second extrusion.

19. A method comprising:
assembling a plurality of parallel extrusions to form one piece of column;
connecting at least one bracket to the assembled parallel extrusions;
disposing one or more first components for operating a liftgate system inside the internal space defined by the assembled parallel extrusions and disposing one or more second components for operating the liftgate system inside a housing; and
connecting the housing and a lift platform to the column.

20. The system of claim 19, wherein the one or more first components include one or more actuation units,
wherein the second components include one or more hydraulic actuators;
wherein the method further comprises:
connecting the one or more actuation units disposed inside the housing to the one or more hydraulic actuators disposed in the internal space of the assembled parallel extrusions via one or more hydraulic hoses.
